(19) United States
(12) Patent Application Publication
(10) Pub. No.: US 2021/0002426 A1
(43) Pub. Date: Jan. 7, 2021

(54) ULTRA STRONG TWO DIMENSIONAL POLYMERS

(71) Applicant: MASSACHUSETTS INSTITUTE OF TECHNOLOGY, Cambridge, MA (US)

(72) Inventors: Michael Strano, Lexington, MA (US); Yuwen Zeng, Allston, MA (US)

(73) Assignee: MASSACHUSETTS INSTITUTE OF TECHNOLOGY, Cambridge, MA (US)

(21) Appl. No.: 16/919,051

(22) Filed: Jul. 1, 2020

Related U.S. Application Data
(60) Provisional application No. 62/869,527, filed on Jul. 1, 2019.

(51) Int. Cl. C08G 69/44

(52) U.S. Cl. CPC C08G 69/44

(57) ABSTRACT

A material having a two-dimensional structure can have high strength properties.

### CLAIM OF PRIORITY

This application claims priority to U.S. Provisional Patent Application No. 62/869,527, filed Jul. 1, 2019, which is incorporated by reference in its entirety.

### STATEMENT OF FEDERAL SUPPORT

This invention was made with Government support under Grant No. W911NF-18-2-0055 awarded by the Army Research Office (ARO). The Government has certain rights in the invention.

### FIELD OF INVENTION

This invention relates to two-dimensional polymers.

### BACKGROUND

Graphene, a single layer 2D hexagonal lattice made of carbon atoms, is the strongest material ever tested. However, its extremely small interlayer van der Waals interaction makes the bulk material (graphite) rather weak. Actually, graphite is considered as one of the softest materials in the world and usually used as a solid lubricant.

### SUMMARY OF THE INVENTION

In one aspect, a method of making a polymer can include contacting

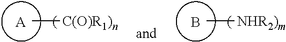

wherein R₁ is a leaving group and R₂ is H or C1-C6 alkyl, n is 2, 3, 4 or 5, m is 3, 4 or 5, and each of the A ring and the B ring is, independently, an aromatic ring,

to form a two-dimensional material.

In certain circumstances, n can be 3 and m can be 3, n can be 2 and m can be 3, n can be 3 and m can be 2, n can be 4 and m can be 2 or n can be 2 and m can be 4.

In certain circumstances, n can be 3, m can be 3, and the two dimensional material can include a structure

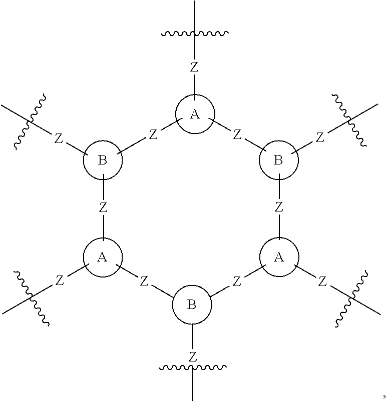

wherein each Z is an amide, urea, or carbamate linkage.

In certain circumstances, R₂ can be H.

In certain circumstances, the A ring can be a carbocyclic aromatic.

In certain circumstances, the carbocyclic aromatic can be phenyl, naphthyl, antrhracenyl, phenanthrenyl, chrysenyl, pyrenyl, corannulenyl, or coronenyl.

In certain circumstances, the B ring can be a heterocyclic aromatic.

In certain circumstances, the heterocyclic aromatic can be pyridinyl, pyrimidinyl, triazinyl, pteridinyl, phenyl, naphthyl, antrhracenyl, phenanthrenyl, chrysenyl, pyrenyl, corannulenyl, or coronenyl.

In certain circumstances, before reaction, the A ring can be

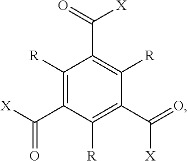

wherein R is H, halo, C1-C6 alkoxy or C1-C6 alkyl and X is a leaving group.

In certain circumstances, before reaction, the A ring can be

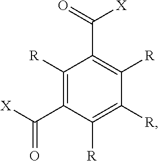

wherein R is H, halo, C1-C6 alkoxy or C1-C6 alkyl and X is a leaving group.

In certain circumstances, before reaction, the B ring can be

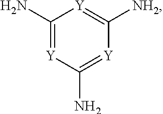

wherein each Y is, independently, N or CR₃, wherein R₃ is H, halo, C1-C6 alkoxy or C1-C6 alkyl.

In certain circumstances, X can be halo, hydroxyl, methoxy, or acetoxy.

In certain circumstances, the two-dimensional polymer can include a structure

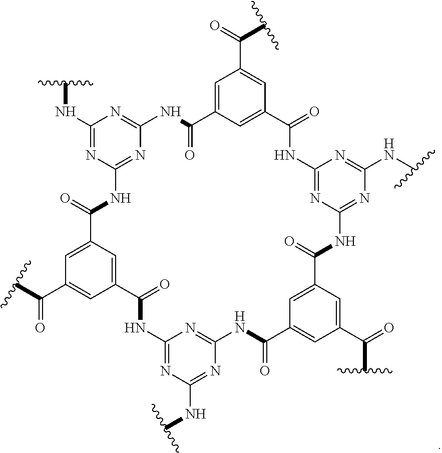

In certain circumstances, the polymer includes a plurality of the structure. In other words, the polymer includes a two-dimensional network including repeating units of the structure.

In certain circumstances, the polymer can have an in-plane structure.

In certain circumstances, the polymer can have an out-of-plane structure.

In certain circumstances, the contacting takes place in a solvent selected from trifluoroacetic acid (TFA), trifluoroethanol (TFE), N-methyl-2-pyrrolidone (NMP), 1,3-dimethyl-2-imidazolidinone (DMI), N,N′-dimethylpropyleneurea (DMPU), or hexamethylphosphoramide (HMPA) and salt solutions thereof. The salt can be a Lewis Acid, such as calcium chloride or lithium chloride.

In another aspect, a material can include a two-dimensional polymer including a plurality of a first aromatic ring and a plurality of a second aromatic ring, each of the first aromatic ring covalently bonded to at least two of the second aromatic ring by amide bonds.

In certain circumstances, the two-dimensional polymer can include a structure

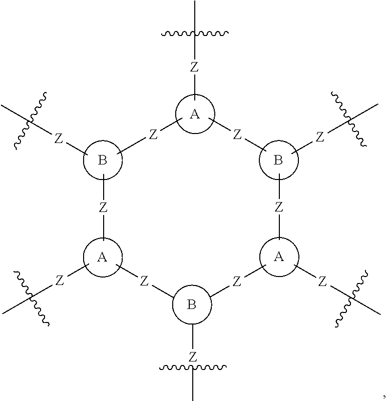

wherein each of the A ring and the B ring is, independently, an aromatic ring and each Z is an amide, urea, or carbamate linkage.

In certain circumstances, the A ring can be a carbocyclic aromatic.

In certain circumstances, the carbocyclic aromatic can be phenyl, naphthyl, antrhracenyl, phenanthrenyl, chrysenyl, pyrenyl, corannulenyl, or coronenyl.

In certain circumstances, the B ring can be a heterocyclic aromatic.

In certain circumstances, the heterocyclic aromatic can be pyridinyl, pyrimidinyl, triazinyl, pteridinyl, phenyl, naphthyl, antrhracenyl, phenanthrenyl, chrysenyl, pyrenyl, corannulenyl, or coronenyl.

In certain circumstances, the A ring can be

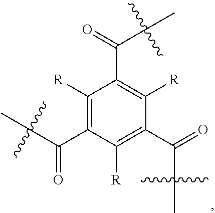

wherein R is H, halo, C1-C6 alkoxy or C1-C6 alkyl.

In certain circumstances, the A ring can be

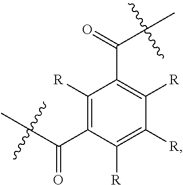

wherein R is H, halo, C1-C6 alkoxy or C1-C6 alkyl. In certain circumstances, the B ring can be

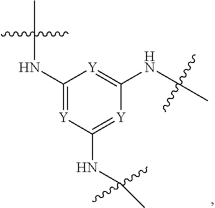

wherein each Y is, independently, N or CR₃, wherein R₃ is H, halo, C1-C6 alkoxy or C1-C6 alkyl.

In certain circumstances, the two-dimensional material can include a structure

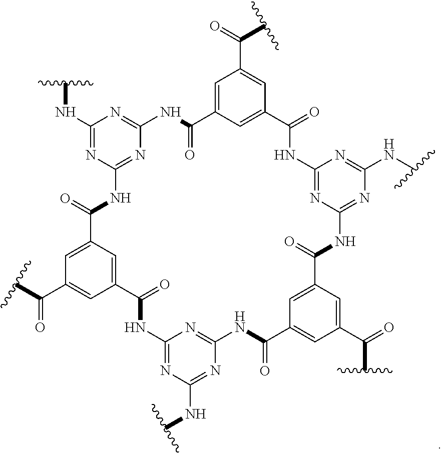

In certain circumstances, the material can have an in-plane structure.

In certain circumstances, the material can have an out-of-plane structure.

In another aspect, a method of forming a coating of a two-dimensional material can include depositing a material described herein on a surface.

Other embodiments are described below and are within the claims.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is a schematic illustration of a two-dimensional material. Panel A shows a representative structure of Kevlar and panel B shows weaves made from Kevlar fibers.

FIG. 2 depicts structure of ultra-strong two-dimensional (2D) polymers. Panel a shows an infinity 2D sheet with amide linkages; panel b shows highly ordered interlayer hydrogen bonding; and panel c shows nanopores on the 2D molecular sheet as panels a and b depict.

FIGS. 3A-3J depict a synthetic approach to the polymers described herein and properties of the material.

FIGS. 4A-4C depict a concentration-thickness dependence for spin coating the material.

FIG. 5 depicts mechanical measurement of the material. Panel a shows a 3D model profile of thin films on holey SiN substrates; panel b shows a schematic illustration of the film; and panel c shows the force curve of nanoindentation.

FIG. 6 depicts a reaction scheme for the material described herein.

FIG. 7 depicts thermal gravimetric analysis of the reaction of

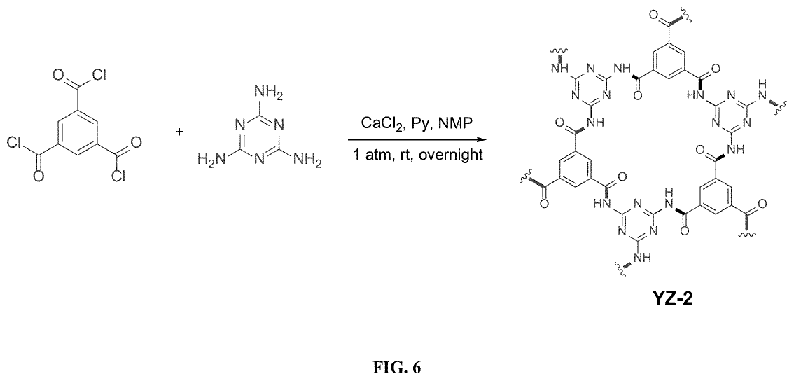

FIG. 6.

FIGS. 8A-8C and 9A-9C depict atomic force microscopy data for the material.

FIG. 10 shows x-ray diffraction data for the material.

FIGS. 11, 12 and 13A-13B show atomic force microscopy data for the material.

FIG. 14 shows mechanical property measurement of the material.

FIGS. 15A and 15B show different possible structures of the material.

FIGS. 16, and 17A-17C depict other potential structural views of the material.

FIGS. 18, 19, 20 and 21A-21B depict additional atomic force microscopy data for the material.

FIGS. 22-25 show a general pathway to making 2D polymers.

FIGS. 26A-26I depict a synthesis and characterization of a two-dimensional (2D) polymer.

FIGS. 27A-27G depict the characterization of YZ-2 thin-films.

FIGS. 28A-28E depict chemical force characterization of YZ-2 thin-films.

FIGS. 29A-29F depict mechanical properties of YZ-2 thin-films.

FIG. 30 is a schematic depicting reaction work up and purification of product.

FIG. 31 is a schematic depicting synthesis of an amorphous product.

FIGS. 32A-32B depict thermogravimetric analysis of compositions described herein.

FIG. 33 depicts FT-IR spectra of compositions described herein.

FIG. 34 depicts powder X-ray diffraction data of compositions described herein.

FIG. 35 depicts transmission electron microscopy images of compositions described herein.

FIGS. 36A-36D depict AFM images and of spin-coated compositions described herein.

FIGS. 37A-37B depict height data.

FIG. 38 depicts a cross-sectional TEM view of a thin film of compositions described herein.

FIG. 39 depicts a cross-sectional TEM view of a thin film of compositions described herein.

FIG. 40 depicts an optical set up for photoluminescence measurements.

FIGS. 41A-41B depict schematic illustrations of an experimental setup.

FIGS. 42A-42B depict photoluminescence (PL) spectra of compositions described herein.

FIG. 43 depict photoluminescence (PL) data of compositions described herein.

FIG. 44 depict bleaching data.

FIGS. 45A-45C depict grazing-incidence wide-angle X-ray scattering of compositions described herein.

FIGS. 46A-46B depict various possible structures of compositions described herein.

FIGS. 47A-47B depict AFM probes.

FIGS. 48A-48B depict surface recognition on different film surfaces.

FIGS. 49A-49B depict chemical force mapping.

FIGS. 50A-50D depict adhesion images.

FIG. 51 depicts a structure including a molecular flip.

FIG. 52 depicts a method of transferring a film.

FIGS. 53A-53C depict AFM images showing homogeneity of films.

FIG. 54 depicts a schematic illustration of nanoindentation using an AFM.

FIG. 55 depicts a force-displacement curve and its modulus fitting.

FIG. 56 depict a schematic illustration of nanoindentation using a nanoindenter.

FIG. 57 depict micrographs of a testing sample. Panel a shows before the test. Panel b shows after break.

FIGS. 58A-58B depict force curves.

FIGS. 59A-59B show an illustration of a scroll fiber and micrographs.

FIGS. 60A-60B show thickness data.

FIG. 61 shows a sample for a tensile test.

FIGS. 62A-62E depict true stress-strain plots of composite scroll fibers and their PC controls. FIG. 62A, V2DP=0.9%. FIG. 62B, V2DP=2.3%. FIG. 62C, V2DP=6.9%. FIG. 62D, V2DP=7.7%. FIG. 62E, V2DP=13.3%.

FIG. 63 depicts a comparison between a YZ-2/PC scroll fiber and a graphene/PC scroll fiber, PC control is also shown. Volume fraction of YZ-2: 6.9%; volume fraction of graphene: 0.19%. Graphene/PC data is reproduced from Science 2016, 353, 364, which is incorporated by reference in its entirety.

FIG. 64 depicts a plot modulus enhancement against volume fraction.

### DETAILED DESCRIPTION

Two-dimensional (2D) materials exhibiting unique electrical and optical properties have attracted significant interests in physics, material science, and nanophotonics. See, for example, Fiori, G. et al. Electronics based on two-dimensional materials. Nature Nanotechnology 9, 768, doi:10.1038/nnano.2014.207 (2014); and Novoselov, K. S. et al. Electric field effect in atomically thin carbon films. Science 306, 666-669, doi:10.1126/science.1102896 (2004), each of which is incorporated by reference in its entirety. Typically, they are synthesized under 2D confinements such as flat interfaces or fixation of monomers in immobilized 2D lattices. However, such approaches suffer from minuscule synthetic efficiencies and transferability issues. Another strategy is to introduce microscopic reversibility, in the cost of bond stability, to achieve 2D crystals after extensive error corrections. See, for example, Colson, J. W. et al. Oriented 2D Covalent Organic Framework Thin Films on Single-Layer Graphene. Science 332, 228-231, doi:10.1126/science.1202747 (2011); and Kandambeth, S., Dey, K. & Banerjee, R. Covalent Organic Frameworks: Chemistry beyond the Structure. J Am Chem Soc 141, 1807-1822, doi:10.1021/jacs.8b10334 (2019), each of which is incorporated by reference in its entirety. As a consequence, resulting materials are associated with low chemical stabilities, which further lead to problematic processabilities. Herein it is demonstrated that 2D irreversible concatenation can occur in solution phase, without any additional 2D input. The resulting 2D polymer is chemically stable, acid-soluble, and ready to self-assemble into highly oriented nano thin-films by an irreversible, parallel yet random stacking. Its superb processability and ultra-high (2.54 GPa) film strength would open up new opportunities to novel applications such as nanocomposite and molecular sieving.

Irreversible 2D polymerization without any 2D confinement is extremely untrivial because organic single bonds inside of the structure free rotate in 3D space, leading to enormous amount of twisty conformations. In the absence of error correction, those conformations would be permanently fixed by covalent bonds as the polymerization goes. See, for example, Sakamoto, J., van Heij st, J., Lukin, O, & Schluter, A. D. Two-Dimensional Polymers: Just a Dream of Synthetic Chemists? Angewandte Chemie International Edition 48, 1030-1069, doi:10.1002/anie.200801863 (2009), which is incorporated by reference in its entirety. From a configuration perspective, each 2D annulation event is a configuration-determining step. Once the nanopore fails to form as a 2D porous lattice predicts, a 2D molecule becomes 3D forever. In that course, the 2D growth, although shares similar activation energies with the random growth, has to pay a fair amount of entropy cost to arrange the molecule roughly in-plane beforehand. Therefore, the 2D/3D divergence is mostly controlled by entropy rather than enthalpy.

Although the in-plane 2D growth is entirely unfavored, we envision that it can still be realized using two strategies. The first one is to significantly reduce the energy barrier of in-planar growth by autocatalysis. Specifically, once negligible amount of 2D seeds are formed out of the very first random growth period, they serve as templates and guide monomers react on their 2D surfaces. This templating pathway would allow a rapid self-replication of 2D structures and therefore outcompete the random growth pathway. Another strategy is to diminish the entropy cost by rigidifying the whole reaction system, including aiming smaller nanopores with planar linkages, reducing degrees of freedom within the nanopore structure, and introducing hyperconjugations to help each segment keeps parallel with its neighbors. Recently, Yaghi and Qiu has demonstrated that irreversible chemistries work when the rotation freedom is entirely removed from the reaction systems. However, the nucleophilic aromatic substitution reaction they used still requires harsh solvothermal conditions and their resulting 2D materials exhibit poor processabilities. See, for example, Zhang, B. et al. Crystalline Dioxin-Linked Covalent Organic Frameworks from Irreversible Reactions. J Am Chem Soc 140, 12715-12719, doi:10.1021/jacs.8b08374 (2018); and Guan, X. et al. Chemically stable polyarylether-based covalent organic frameworks. Nature chemistry 11, 587-594, doi:10.1038/s41557-019-0238-5 (2019), each of which is incorporated by reference in its entirety.

A type of ultra-strong polymers described herein can be viewed as a two-dimensional (2D) version of Kevlar. The material consists of 2D molecules that have an extended rigid structure in two dimensions while highly ordered hydrogen bonds in the third dimension. Unlike typical extended one-dimensional/two-dimensional (1D/2D) materials, the polymer can be dispersed easily and quickly self-assemble to form atomically flat thin films on different substrates by just simple spin-coating or drop-casting. The processability of the polymer makes it different from the 2D materials that previously could not be processed. The films are insoluble in water and organic solvents (except strong acids) and are stable to high temperature. The structure provides an ultra-high strength and toughness can be achieved by strong interlayer hydrogen bonding, which is brought by the specific structure design. The polymers can be used as body armour, structural material, nanofiltration, and gas separation.

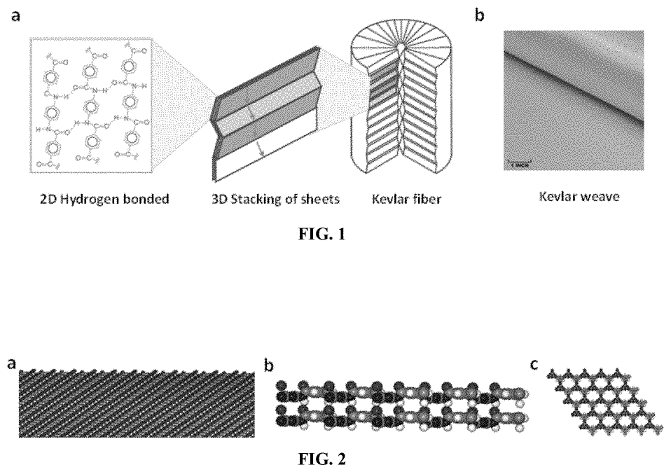

Since the dawn of Kevlar in the late 1960s, structures which may lead to high strength were highly thought by both industrial and academic communities. Structure of Kevlar was then revealed, suggesting clear and strong interchain hydrogen bonding interactions. However, the molecular sheet formed by hydrogen bonding stacks loosely and somewhat misoriented in long-range, which retards to get its theoretic limit strength (FIG. 1, panel a). Moreover, Kevlar can only offer strength along one dimension. To get the two-dimensional strength, elaborate fabrication of Kevlar weave is required and the specific strength (strength per unit mass) has thus halved (FIG. 1, panel b).

To address the problems in Kevlar and Graphene, 2D ultra-strong polymers can be designed that can include a highly ordered 2D network that pre-fix each atom in plane to get high intrinsic strength and strong interlayer interaction for perfect three-dimensional (3D) stacking to achieve excellent bulk strength (FIG. 2, panel a). A structure having 2D rigid aromatic backbones with amide bonds as linkages can meet the requirements (FIG. 2, panel b). To help the structure building and hydrogen bond alignment, nanopores can add some flexibility to the 2D structure (FIG. 2, panel c). It should be emphasized here that the introducing of nanopores also offers new opportunities for nanofiltration, gas separation, as well as other important applications.

This concept seems close to the existing 2D covalent organic frameworks (2D COFs), however, they are totally different in details. The whole COF field is built on reversible chemistries, such as boroxine, imine formations and other condensations. The key idea of using reversible bond formation in the referenced approach is to correct defects formed during the reaction course and achieve thermodynamic control, thus offering highly ordered structures. As consequences of the reversible bond formation, COFs are found to be both thermodynamically unstable and experimentally unscalable. Moreover, due to its insoluble and infusible features, it is practically impossible to post-fabricate COF powders.

The approach described here involves moving from reversible chemistry to irreversible chemistry, shifting the material synthesis to a kinetically controlled process from a thermodynamically controlled process. One-step solution phase synthesis of 2D extended network material by irreversible chemistry has not been achieved prior to the approach described herein. Based on those major differences above, this new type of material can be considered a Hydrogen bond Oriented Extended Material (HOEM).

In one aspect, a method of making a material can include contacting

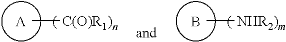

wherein R₁ is a leaving group and R₂ is H or C1-C6 alkyl, n is 2, 3, 4 or 5, m is 3, 4 or 5, and each of the A ring and the B ring is, independently, an aromatic ring, to form a two dimensional material.

The Lewis base sites on the aromatic ring in either monomer A or B can assist with overcoming solubility problems for the material.

A two dimensional material can be formed, for example, when n cis 3 and m is 3, n is 2 and m is 3, n is 3 and m is 2, n is 4 and m is 2 or n is 2 and m is 4.

In certain circumstances, n can be 3, m can be 3, and the two dimensional material can include a structure

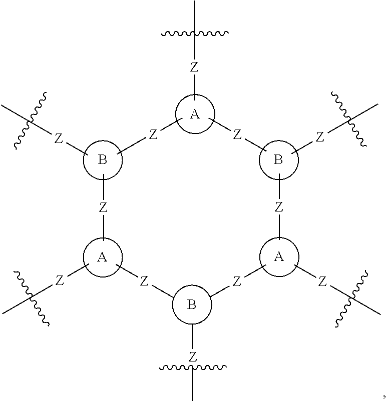

wherein each Z is an amide, urea, or carbamate linkage.

In certain circumstances, R₂ can be H.

Each ring can be an organic ring structure. Examples of 2D ring structures that could be modified to form the polymers described here can be found, for example, in Huang, et al., Nature Reviews Materials, Volume 1, Oct. 2016, pages 1-19, which is incorporated by reference in its entirety.

In certain circumstances, the A ring can be a carbocyclic aromatic.

In certain circumstances, the carbocyclic aromatic can be phenyl, naphthyl, antrhracenyl, phenanthrenyl, chrysenyl, pyrenyl, corannulenyl, or coronenyl.

In certain circumstances, the B ring can be a heterocyclic aromatic.

In certain circumstances, the heterocyclic aromatic can be pyridinyl, pyrimidinyl, triazinyl, pteridinyl, phenyl, naphthyl, antrhracenyl, phenanthrenyl, chrysenyl, pyrenyl, corannulenyl, or coronenyl.

In certain circumstances, before reaction, the A ring can be

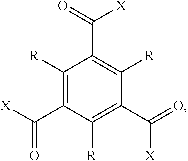

wherein R is H, halo, C1-C6 alkoxy or C1-C6 alkyl and X is a leaving group.

In certain circumstances, before reaction, the A ring can be

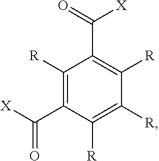

wherein R is H, halo, C1-C6 alkoxy or C1-C6 alkyl and X is a leaving group.

In certain circumstances, before reaction, the B ring can be

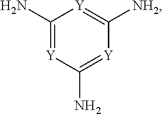

wherein each Y is, independently, N or CR₃, wherein R₃ is H, halo, C1-C6 alkoxy or C1-C6 alkyl.

In certain circumstances, X can be halo, hydroxyl, methoxy, or acetoxy.

In certain circumstances, the two-dimensional material can include a structure

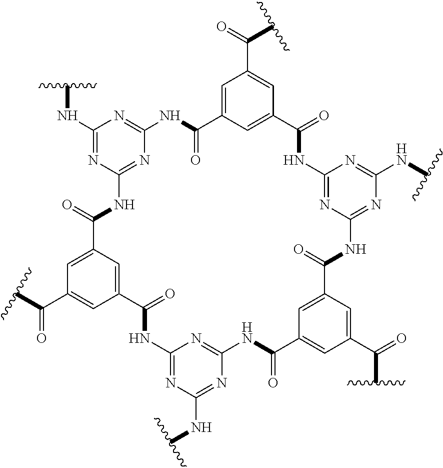

In certain circumstances, the material includes a plurality of the structure. In other words, the material includes a two-dimensional network including repeating units of the structure.

In certain circumstances, the material can have an in-plane structure. In certain circumstances, the material can have an out-of-plane structure. The in-plane structure is a structure in which the angle of the amide or other polar bonds are relatively small, for example, may be less than 30 degree. The out-of-plane structure is a structure having the amide or other polar bonds out of the plane of the ring structures. The out-of-plane structure can create high density of interlayer hydrogen bonds in the structure and thus have enhanced mechanical properties.

In certain circumstances, the contacting takes place in a solvent selected from trifluoroacetic acid (TFA), trifluoroethanol (TFE), N-methyl-2-pyrrolidone (NMP), 1,3-dimethyl-2-imidazolidinone (DMI), N,N′-dimethylpropyleneurea (DMPU), or hexamethylphosphoramide (HMPA) and salt solutions thereof. The salt can be a Lewis Acid, such as calcium chloride or lithium chloride.

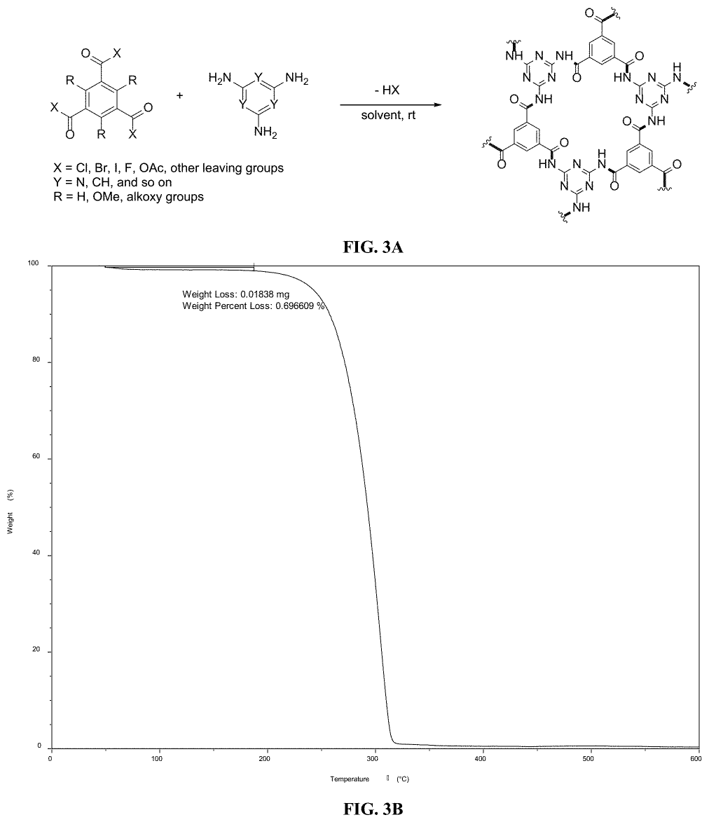

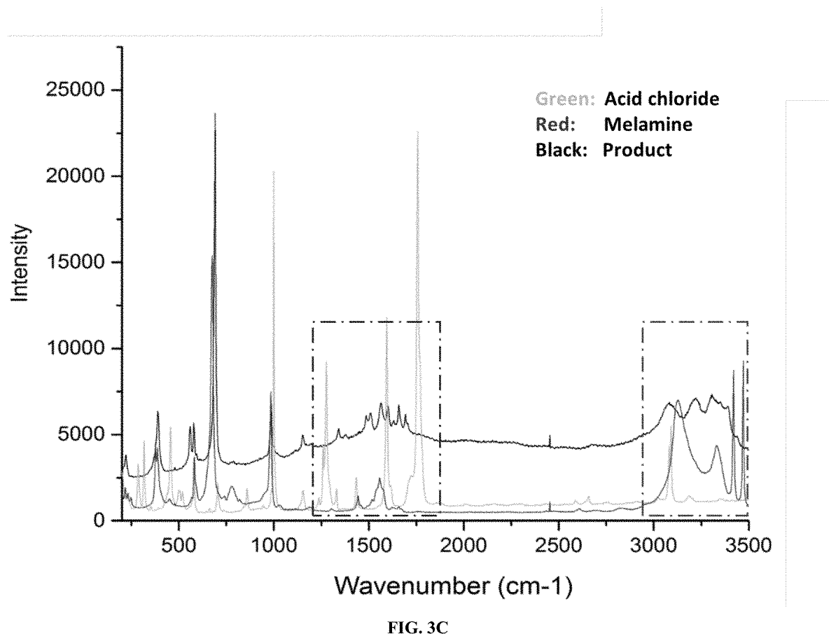

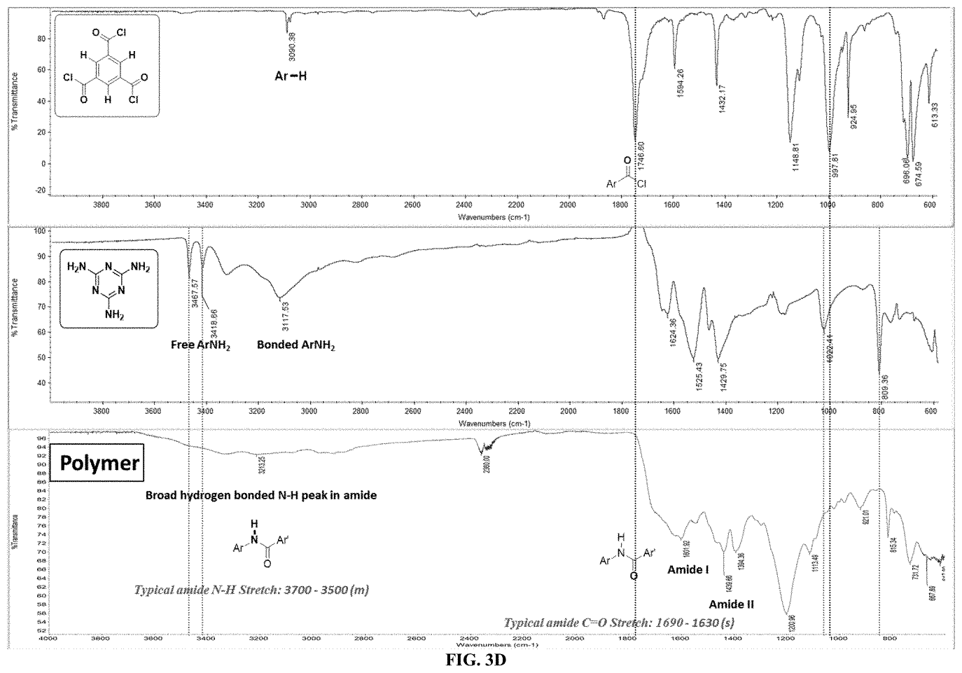

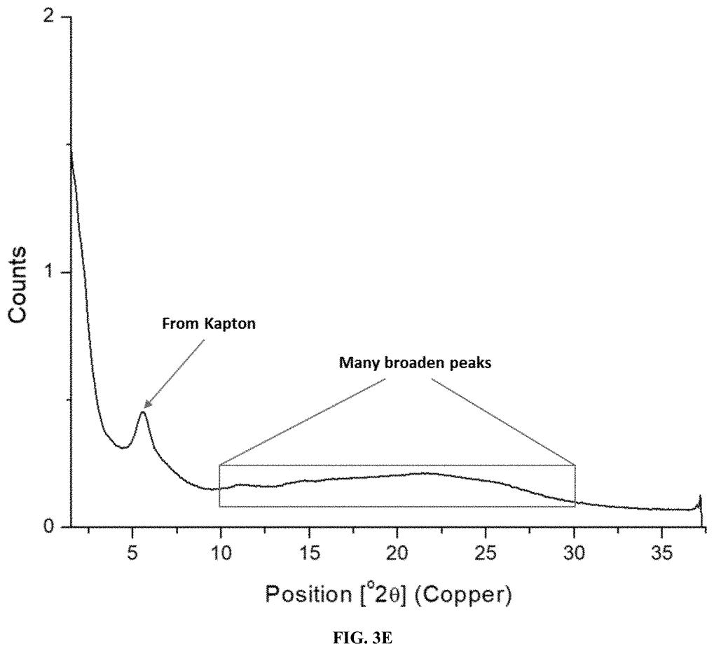

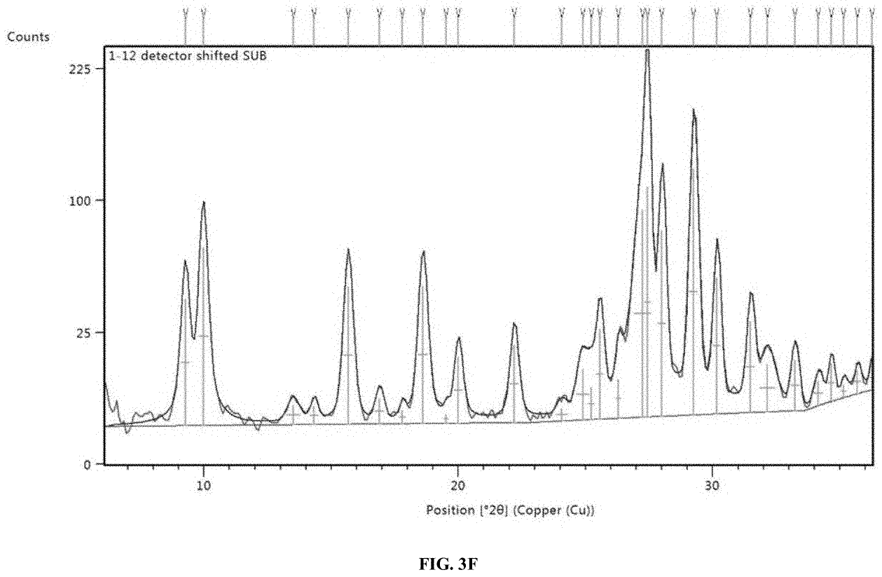

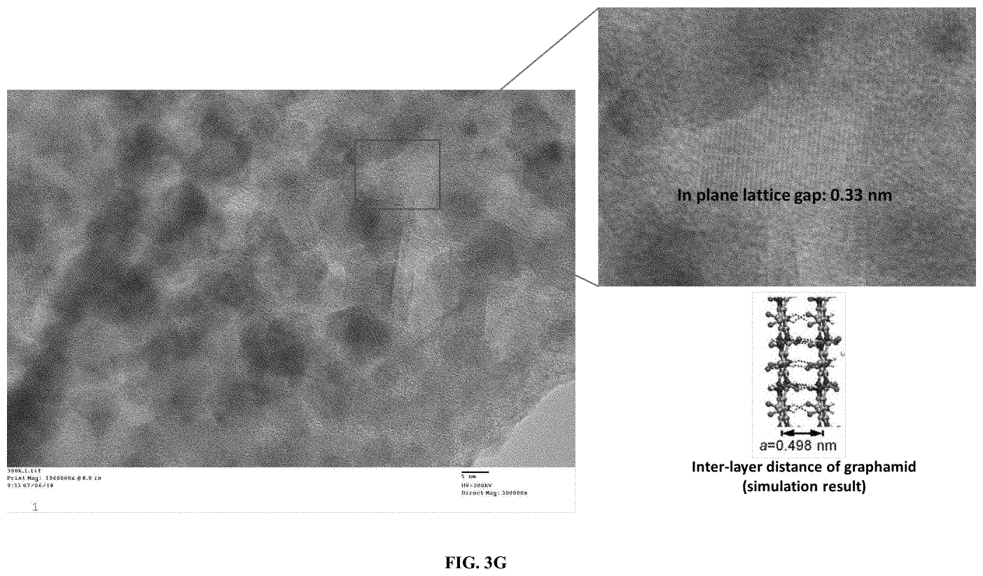

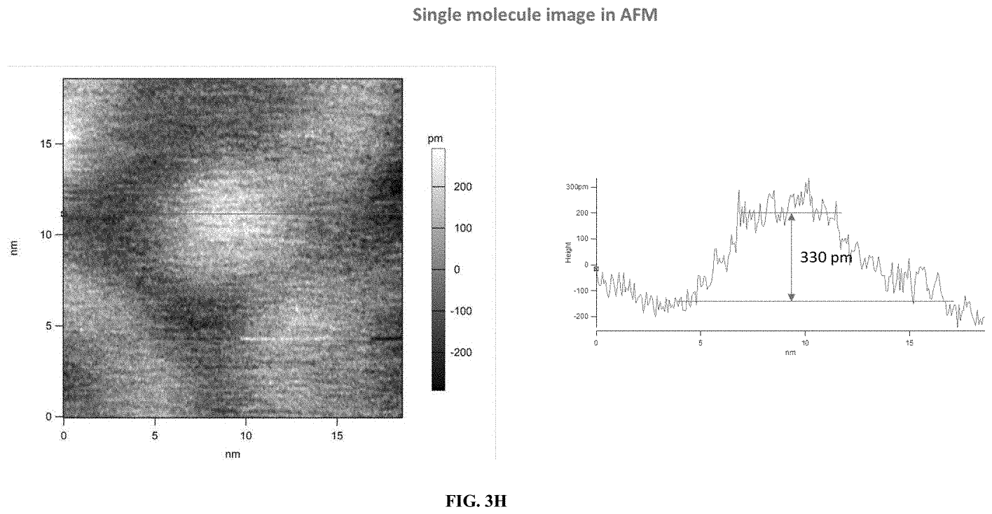

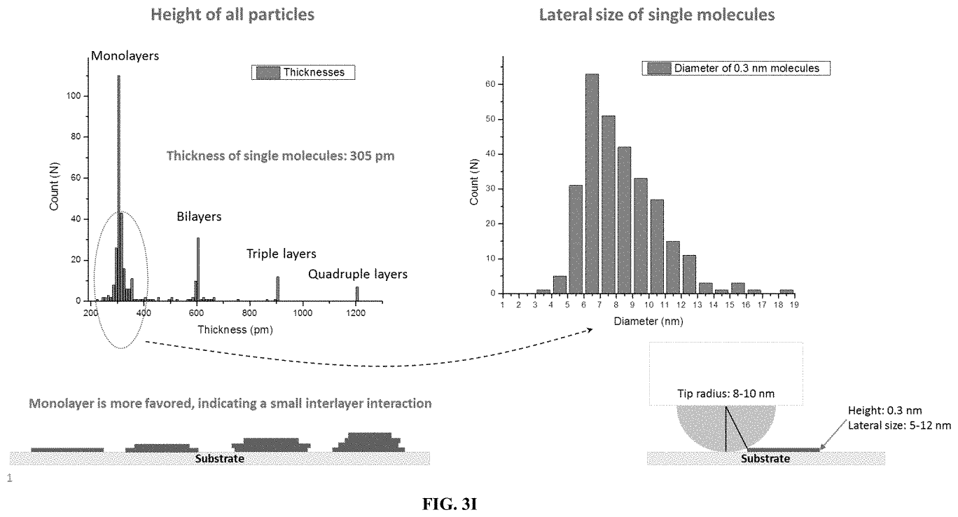

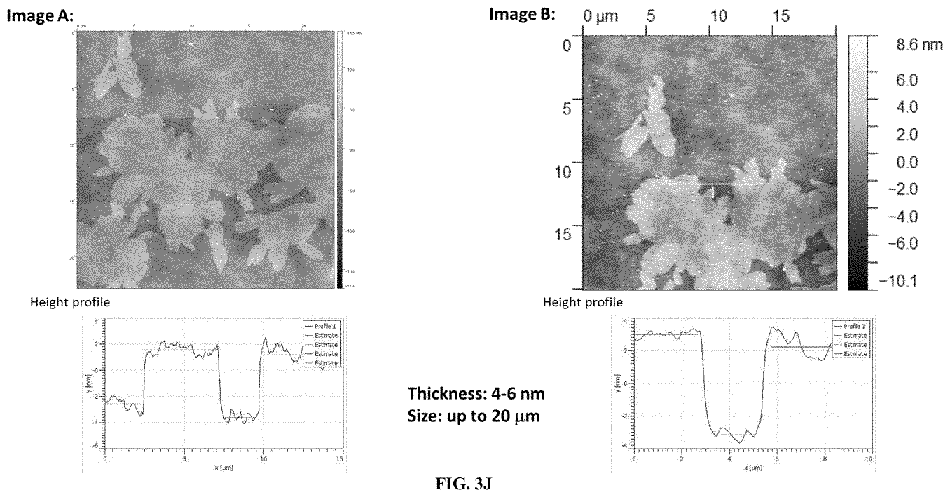

The reaction conditions are important in determining whether the in-plane or out-of-plane structure is created. This is the case, in part, because the reaction is kinetically controlled. This selectivity can be important because in order to get strong interlayer hydrogen bonding, the amide bonds need to orient out of the molecular plane, and the out-of-plane structure is actually energetically unfavored compared to the in-plane structure. The energy difference is large (˜70 Kcal/nanopore), making the achievement of the out-of-plane structure surprising. A common feature of those solvents is they are strong Lewis bases thus can serve as great hydrogen bond acceptors. Additives can also enhance the synthesis. The salts such as CaCl₂, LiCl et.al are Lewis acids here, can help to dissolve the 2D molecules and also facilitate this reaction. Solubility is important because once the 2D polymer molecule leave the reaction system, it stops growing. According to simulation, the strength of bulk material has a strong correlation with the molecular size. Figures showing properties of the in-plane structure include FIG. 3B (TGA), FIG. 3C (Raman), FIG. 3F (powder XRD), FIG. 3G (HR-TEM), FIG. 3H (single molecule image), FIG. 3I (statistics), FIG. 3J (self-assembly), and FIG. 10 (XRD). The others relate to the out-of-plane structure.

In another aspect, a material can include a two dimensional material including a plurality of a first aromatic ring and a plurality of a second aromatic ring, each of the first aromatic ring covalently bonded to at least two of the second aromatic ring by amide bonds.

In certain circumstances, the two dimensional material can include a structure

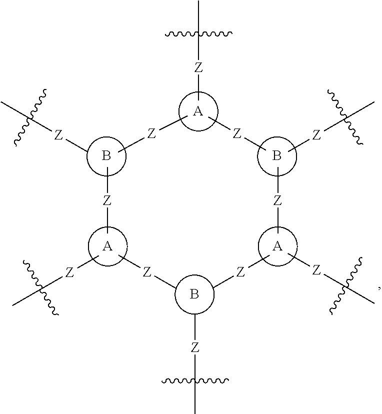

wherein each of the A ring and the B ring is, independently, an aromatic ring and each Z is an amide, urea, or carbamate linkage.

In certain circumstances, the A ring can be a carbocyclic aromatic.

In certain circumstances, the carbocyclic aromatic can be phenyl, naphthyl, antrhracenyl, phenanthrenyl, chrysenyl, pyrenyl, corannulenyl, or coronenyl.

In certain circumstances, the B ring can be a heterocyclic aromatic.

In certain circumstances, the heterocyclic aromatic can be pyridinyl, pyrimidinyl, triazinyl, pteridinyl, phenyl, naphthyl, antrhracenyl, phenanthrenyl, chrysenyl, pyrenyl, corannulenyl, or coronenyl.

In certain circumstances, the A ring can be

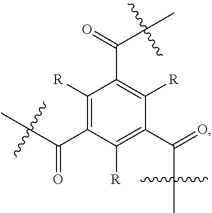

wherein R is H, halo, C1-C6 alkoxy or C1-C6 alkyl.

In certain circumstances, the B ring can be

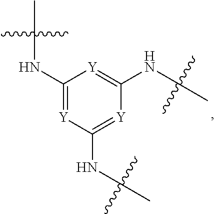

wherein each Y is, independently, N or CR₃, wherein R₃ is H, halo, C1-C6 alkoxy or C1-C6 alkyl.

In certain circumstances, the two-dimensional material can include a structure

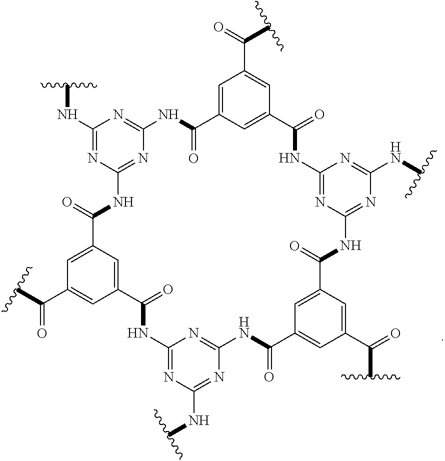

In another aspect, a method of forming a coating of a two-dimensional material can include depositing a material described herein on a surface. The coating can be formed by spin coating, dip coating or drop coating the material on the surface, for example, in a solution. The solvent can be polar and protic, for example, TFA.

Results and Discussions:

Synthesis: 1,3,5-Benzenetricarboxylic acid chloride and melamine were selected as monomers. The structure of these two components may vary but basically they are tricarbonyl-triamine system to form small sized nanopores. The advantages of using these reagents are cheap and stable. The combination of these two reactants in a mixed solution (NMP/CaCl₂) at room temperature gives a pale-yellow gel after overnight stirring. The gel is then dispersed in ethanol and filtered to offer brown-yellow pellets (FIG. 3A).

FIG. 3A shows an example of the synthesis of 2D polymers. The solvent is found to be crucial to this reaction. Different structures, such as an 3D amorphous structure, can be obtained when different solvent systems are used. Basically, highly polarized solvents are required. The reaction is fast, reproducible, and scalable. The monomers can be readily supplied in bulk. The in-plane product can be dissolved in water, methanol and trifluoroacetic acid.

Thermogravimetric analysis shows that the in-plane product is pure and have a clear decompose temperature (shown in FIG. 3B).

Raman spectra are shown in FIG. 3C. No starting material peaks remain in the spectrum of in-plane product.

Infrared spectra of starting materials and the out-of-plane product are shown in FIG. 3D, depicting full conversion (no peaks from monomers were observed in product spectrum), that amide bonds has formed (verified by IR spectroscopy, <1700 cm⁻¹) and showing that the amides are highly hydrogen bonded (proved by the broadening and shifting of amide N—H peaks).

Powder x-ray diffraction of the out-of-plane product is shown in FIG. 3E. There are no sharp peaks in this amorphous sample which has a number of broad peaks in large angle area; Overall, this structure shows low crystallinity. In contrast, a crystalline form of the in-plane product has an x-ray diffraction pattern shown in FIG. 3F, indicating a highly ordered structure. FIG. 3G depicts a high-resolution transition electron microscopy image, which evidences a highly ordered structure for the in-plane structure.

FIGS. 3H-3J depict atomic force microscopy results of the in-plane structure showing an interlayer spacing, and average thickness of a layer of the material. A monolayer can be preferred. In FIG. 3J, nanosheets form by self-assembly. The nanosheets are large and uniform. The nanopore size can be tuned by changing the R group on the benzene ring. It has long been known that a tunable nanopore size was highly thought in gas separation, nanofiltration, and desaltination.

It should also be mentioned that the melamine we use here offers Lewis base site for protonation with medium strong acid such as TFA (trifluoroacetic acid). The protonated 2D sheets disperses well in the solution, thus allowing further fabrication processes.

Introducing Lewis base containing components can be the magic bullet for fabrication. Unlike the sticky and non-volatile 100% of H₂O₄ used in Kevlar industry, TFA can be easily removed and recycled during the factory fabrication. Also, this idea has not been found in COF area due to the intrinsic instability of COF molecules. The disperseability of the material readily permits processing of the 2D material.

Characterization of the out-of-plane product: The primary structure of this material has been easily demonstrated by FTIR and Raman, which clear show amide group. Also, the intermolecular hydrogen bonding is proved by the broadening and shifting of the N—H peaks in FTIR. However, getting a clear image of the higher structure can be challenging. The 2D feature was observed for single molecules in AFM images, in which single flakes tend to form bilayer aggregates and then form nanosheets.

The out-of-plane structure has asymmetric surfaces, proving by chemical AFM. Preliminary results showed that the chemically modified AFM tip has different adhesion forces with different surfaces of the molecule, revealing an asymmetrical nature of 2D molecules.

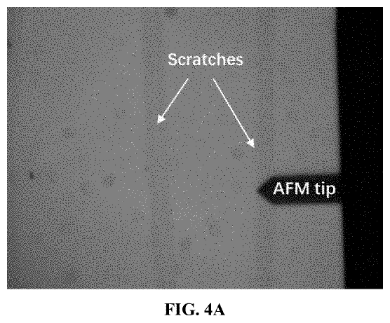

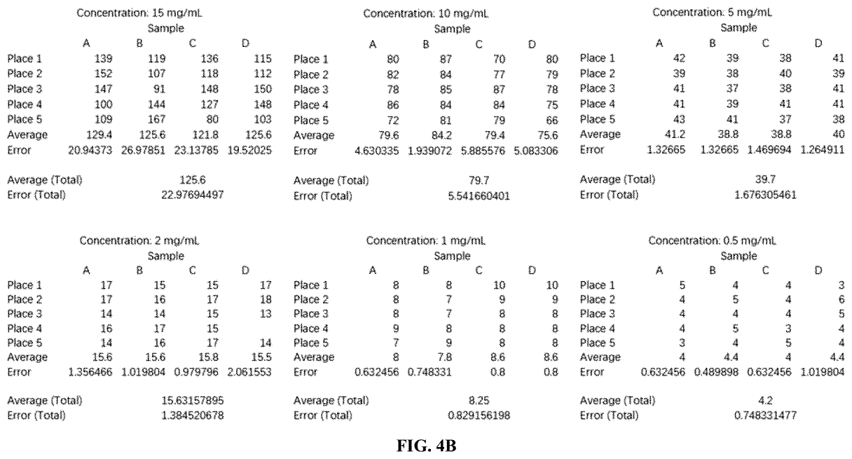

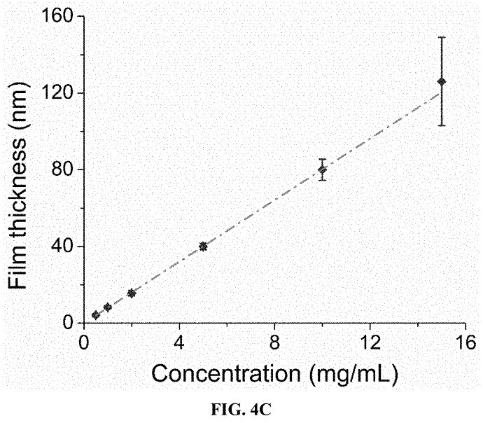

Self-assembly and Fabrication of the out-of-plane product: The product dissolves in TFA very well to generate a homogenous solution and forms thin films on different substrates by simple drop-casting or spin-coating. The thickness of the thin films on Si wafer varies from 4 nm to 100 nm by just changing the solution concentrations used in the spin-coating process (FIGS. 4A-4C). The correlation allows for reproducible coatings to be made by this method. The surface roughness is also checked with AFM and found to be quite small (˜1nm), implying atomically flat surfaces. For other substrates such as mica and Ni, even simple drop casting is enough to form perfect thin films.

For example, referring to FIGS. 4A-4C, thin films were made by spin-coating on Si wafer (2000 rpm, 1 min). The data are shown in the table:

| | | | | | |
|---|---|---|---|---|---|
| Solution concentration | 0.5 | 1 | 2 | 5 | 10 |
| (mg/mL) | | | | | |
| Film thickness (nm) | 4.2 | 8.3 | 15.6 | 40 | 80 |
| Error (nm) | 0.75 | 0.83 | 1.4 | 1.7 | 5.5 |

Each concentration contains 4 samples, each sample was checked at 5 different places. Thickness can be measured by AFM at scratches. By simple spin-coating, uniform films can be formed on SiO₂ wafer. The thickness is controllable. Films can also be made by simple drop-casting on some surfaces (for example: mica, metals or other materials). The films are flat and uniform (not shown here).

A nano-indentation experiment gave a 2D elastic modulus of 17.8 GPa, which is similar to typical plastics such as polycarbonate, polystyrene, and nylon. The unique combination of an ultra-high strength and a medium Young's modulus implies a silk-like ultra-strong material, which is perfect for shock mitigation and structural use. Furthermore, its thickness tunable nature and comparable modulus render it an excellent material for nanocomposites with resins. These results may be underestimated due to the deformation of the SiN substrates used in nano-indentation measurements. Higher modulus and strength are expected possible if bulk and solid substrates are used instead.

These HOEMs (hydrogen bond oriented extended materials) represent a type of topologically new polymers. It contains a highly ordered periodical structure in two dimensions and highly oriented hydrogen bonds in the third dimension. Based on the delicate design, this material was found to be super strong (high strength and high toughness), affording an ultra-high ultimate tensile strength (2.54 GPa, close to Kevlar) and a 2D elastic modulus of 17.8 GPa (close to polycarbonate). Moreover, the atomically precise nanopores on the 2D molecules would open up important industrial applications such as structural use, gas separations and desalinations. See, for example, High strength films from oriented, hydrogen-bonded “graphamid” 2D polymer molecular ensembles. Scientific Reports. 2018, 8, 3708; and Covalent organic frameworks: chemistry beyond the structure. J. Am. Chem. Soc. 2019, 141, 1807, each of which is incorporated by reference in its entirety.

Referring to FIG. 6, in the synthesis of the material, solvent can be important to control material properties (for example, THF, TFE, DCM and acetone). In general, high-polar solvents with strong hydrogen bond acceptor ability are favored (e.g. DMI, HMPA, NMP or others). Adding of salts like CaCl₂ makes the reaction quicker and presumably gives molecules with larger lateral size. Also, the product is insoluble in water and organic solvents. However, it can be dissolved in TFA, a low boiling point organic acid (due to the protonation of melamine ring).

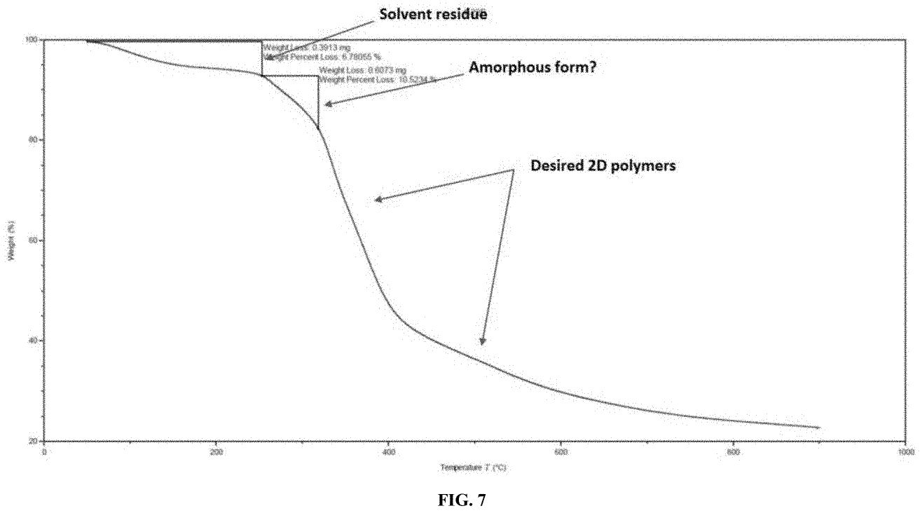

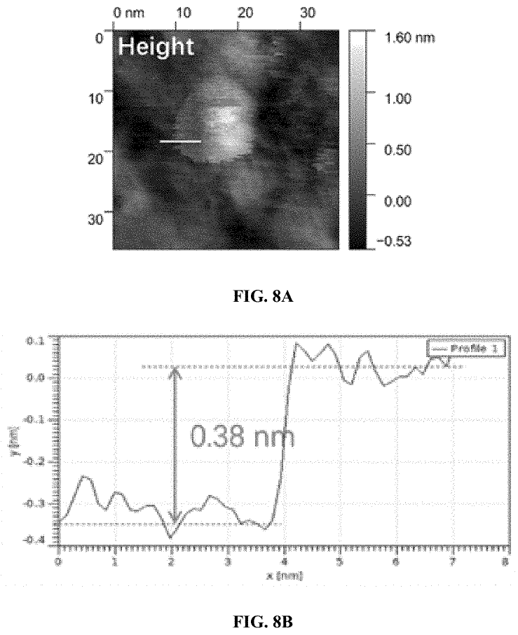

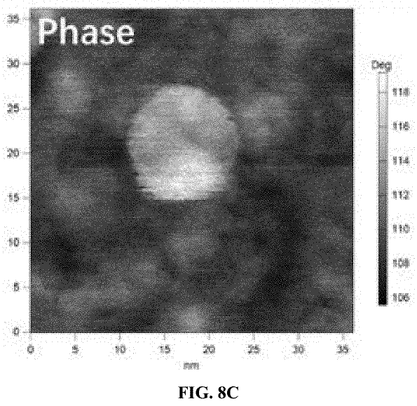

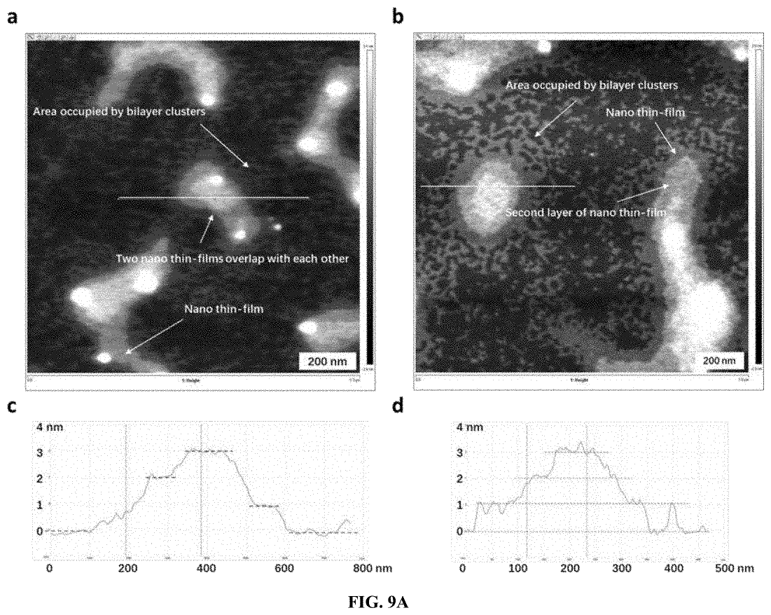

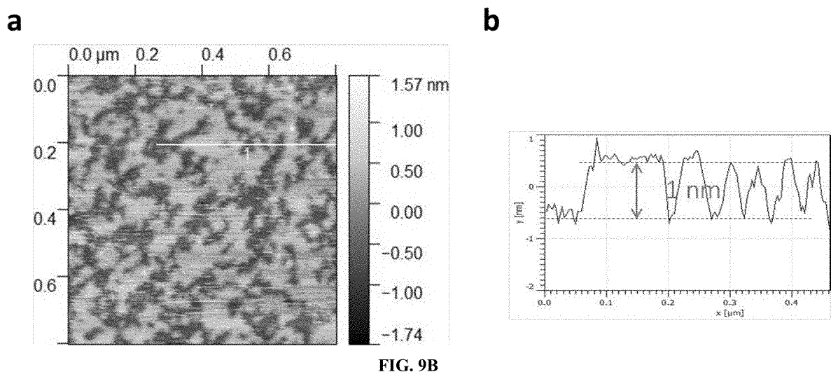

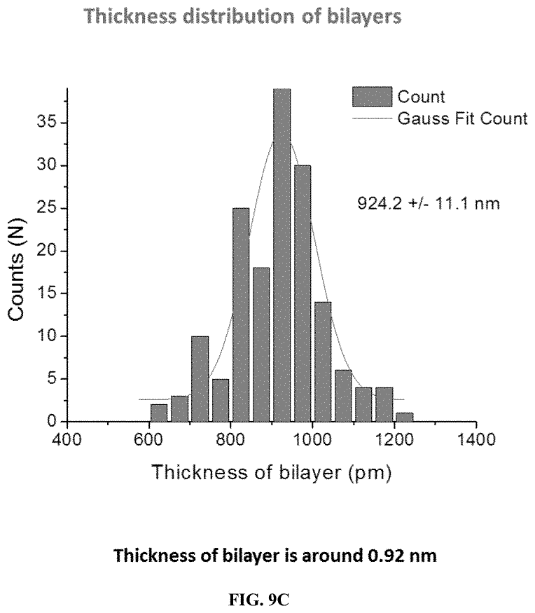

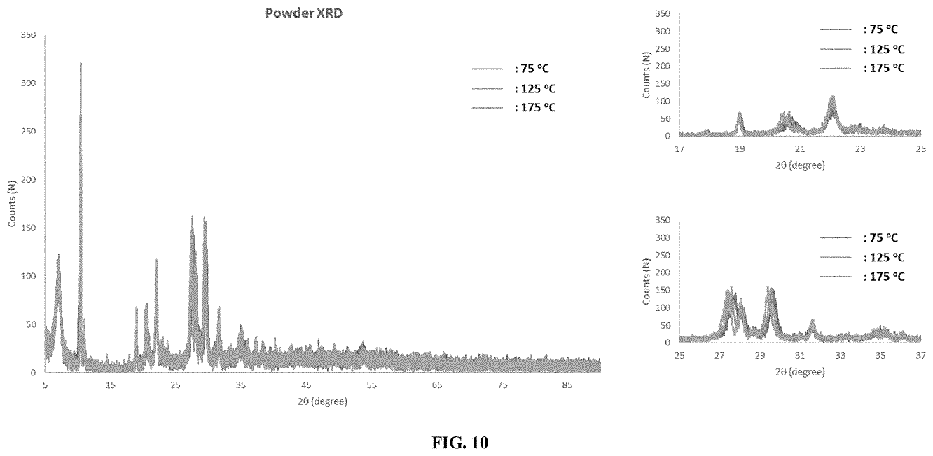

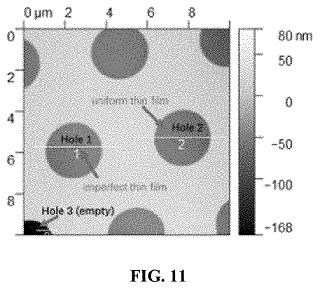

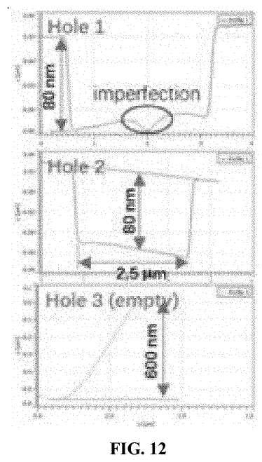

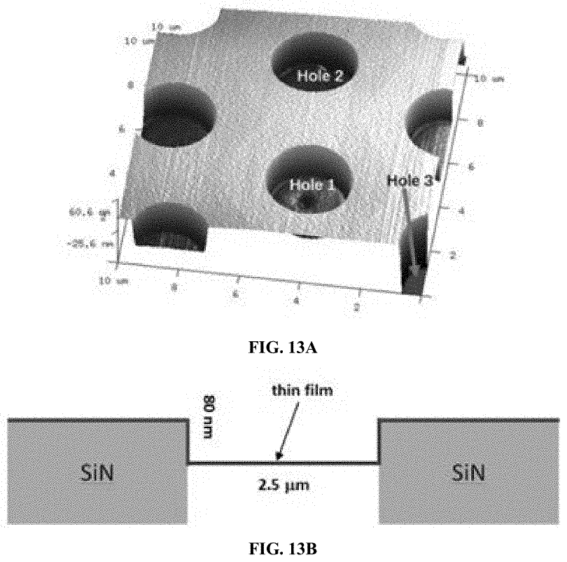

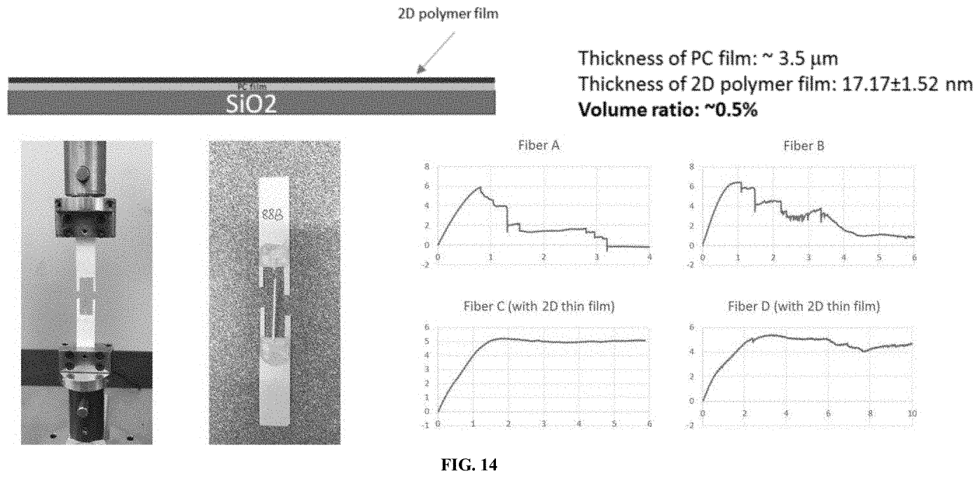

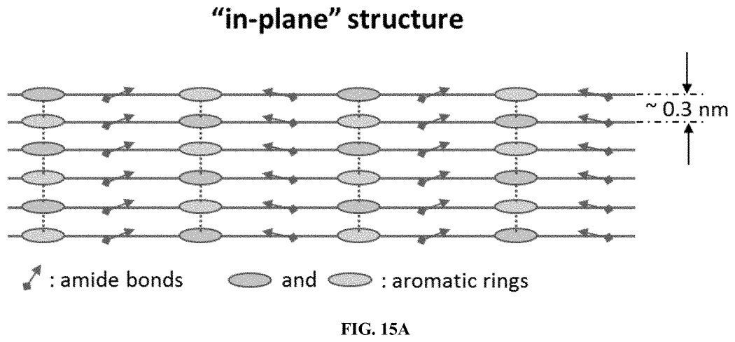

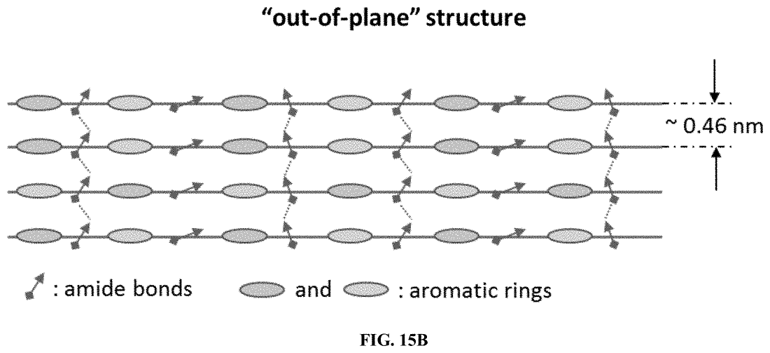

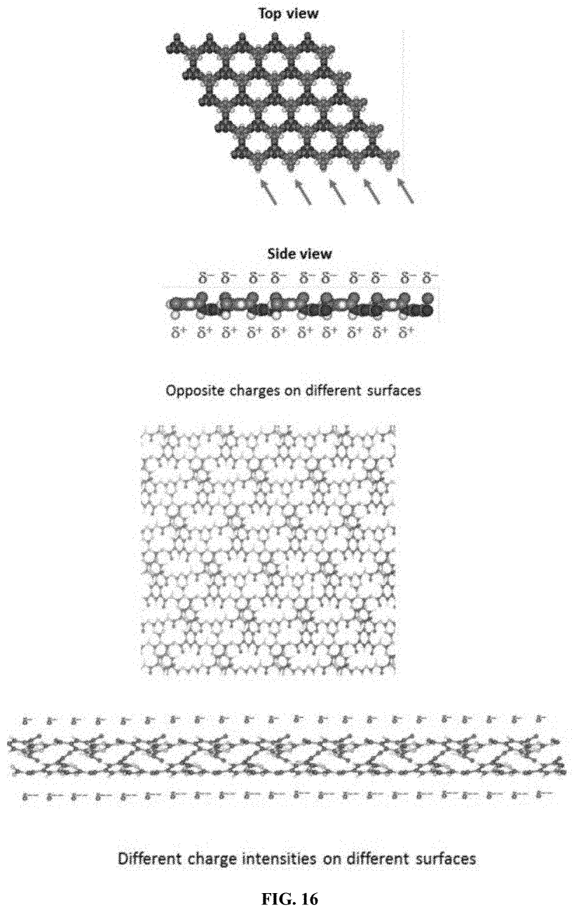

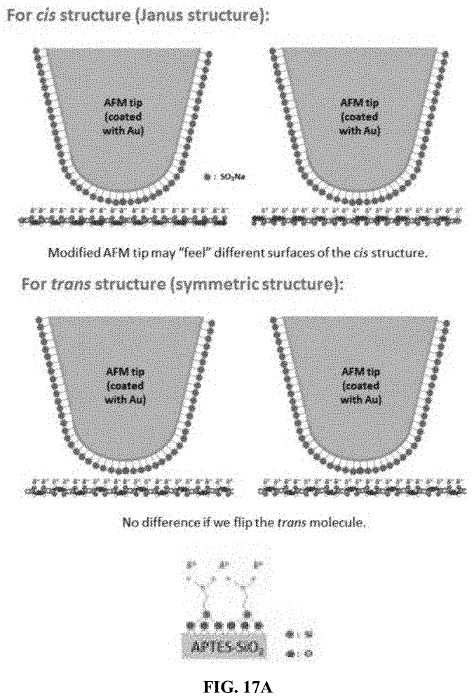

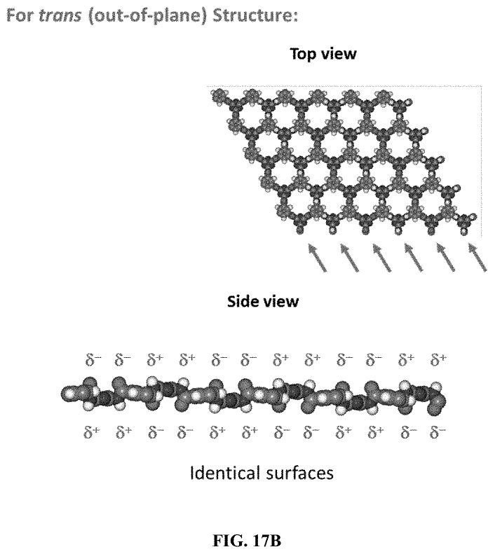

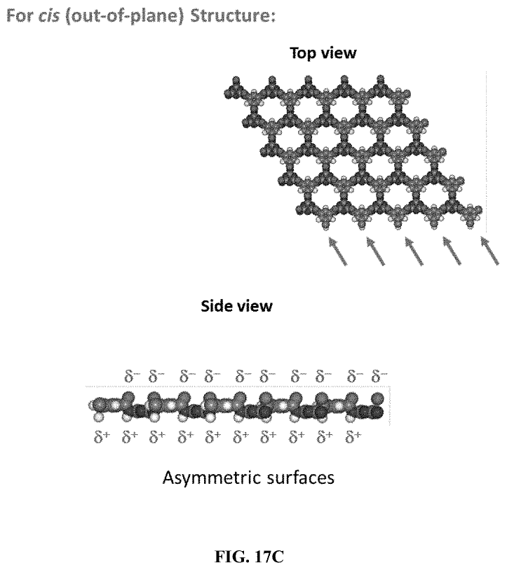

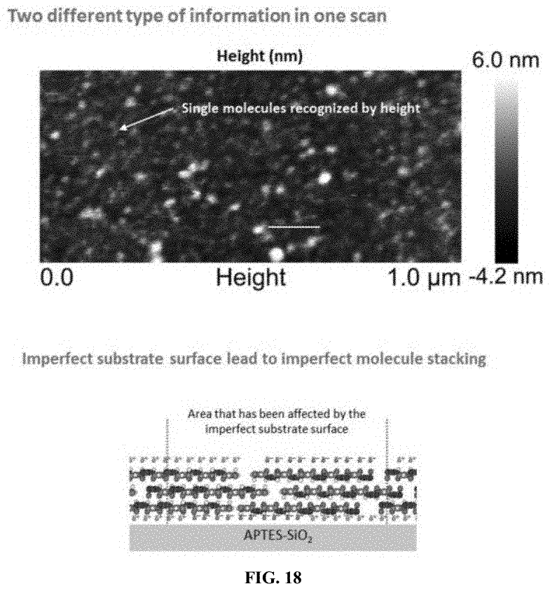

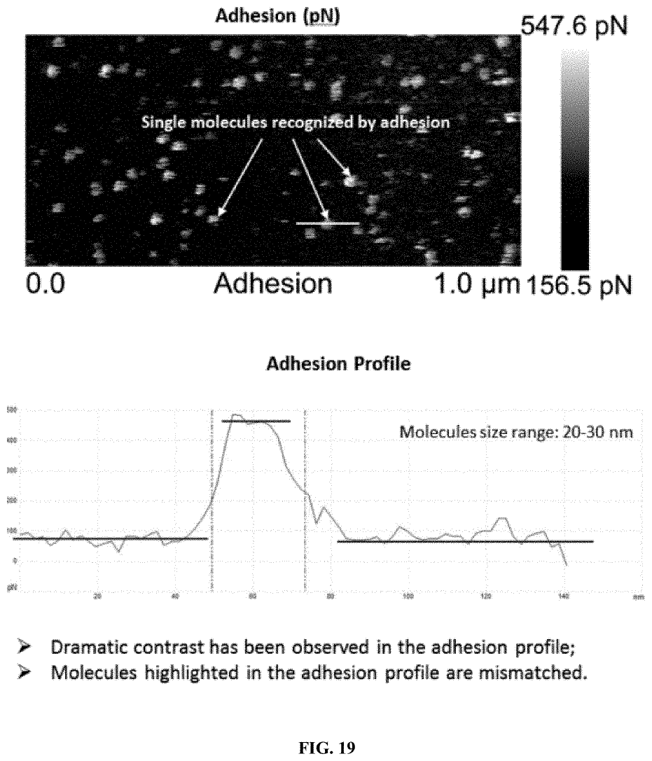

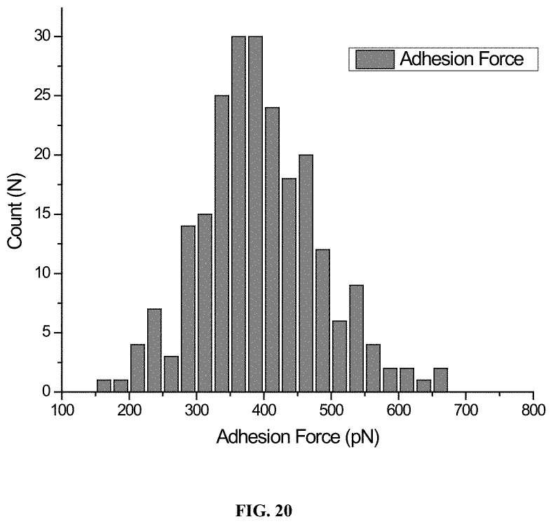

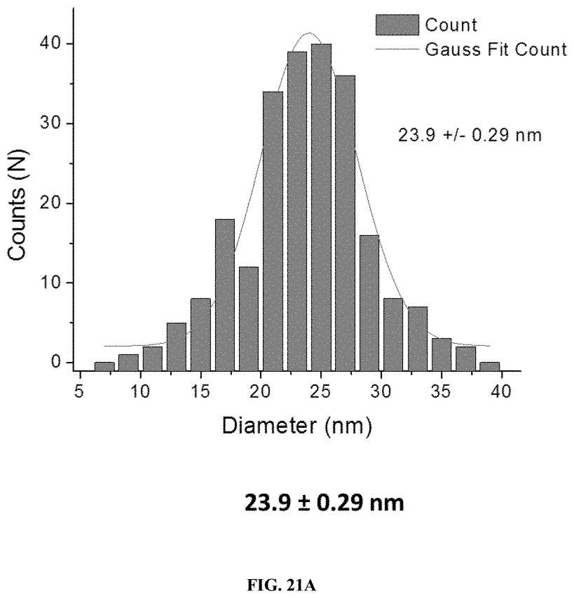

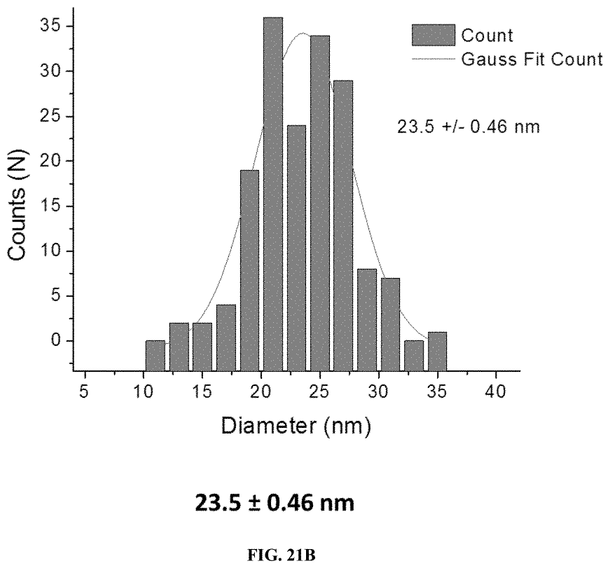

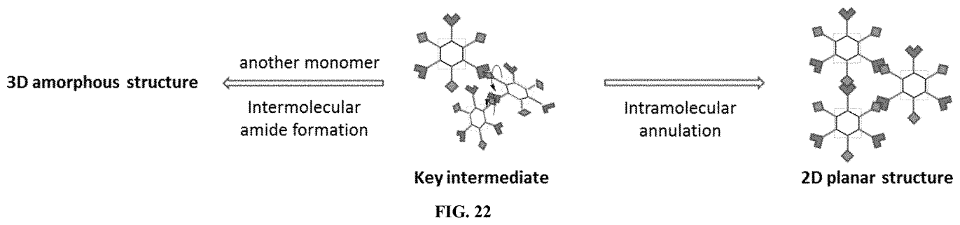

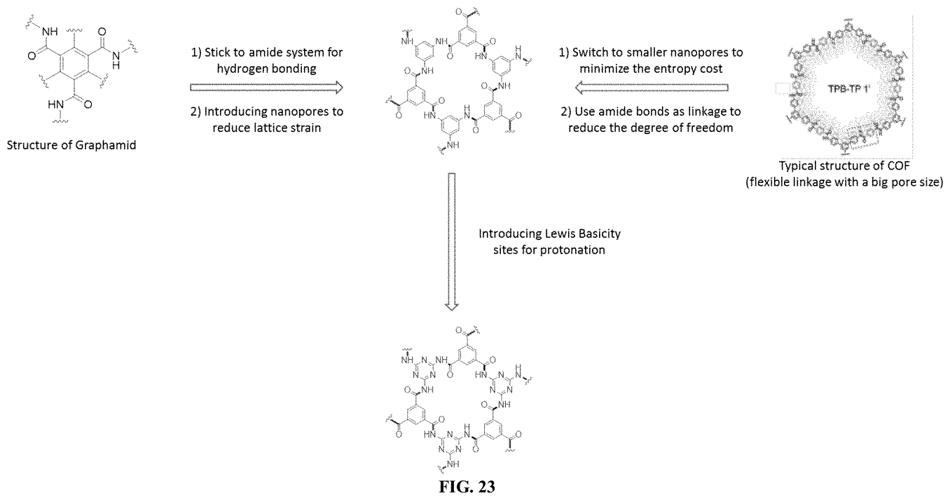

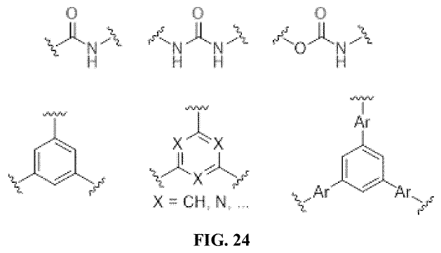

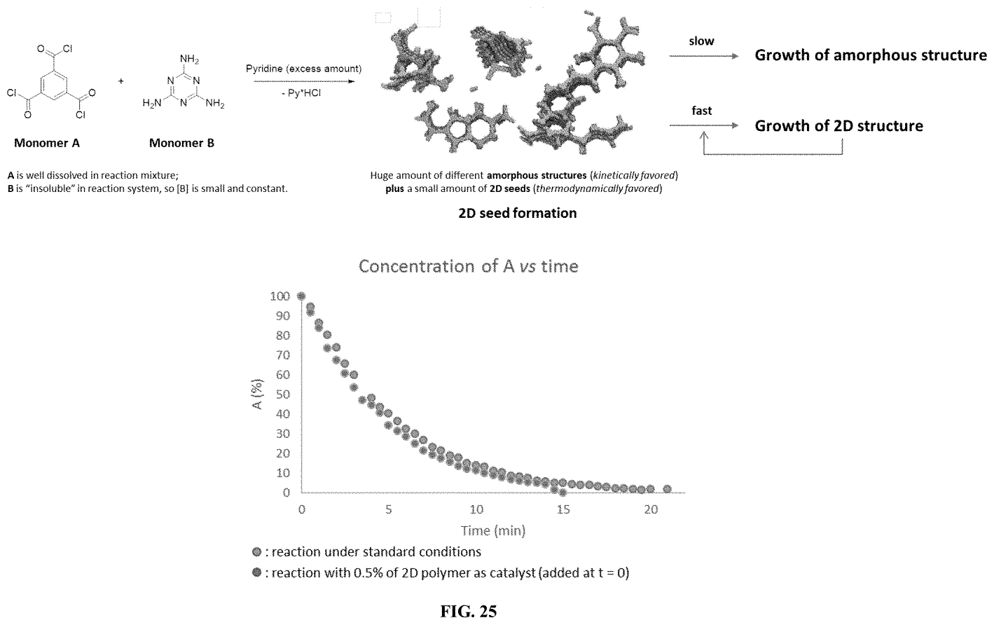

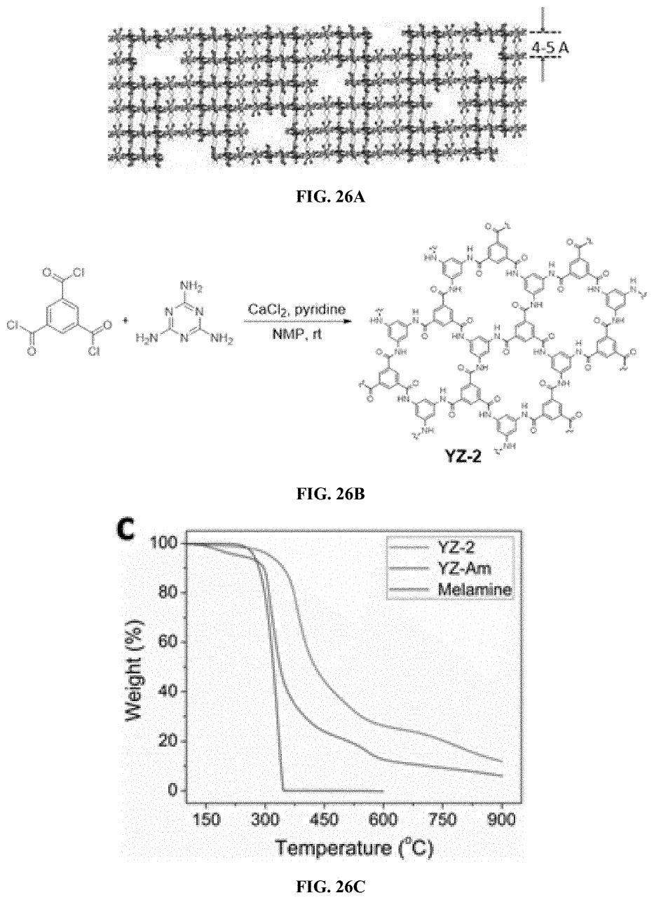

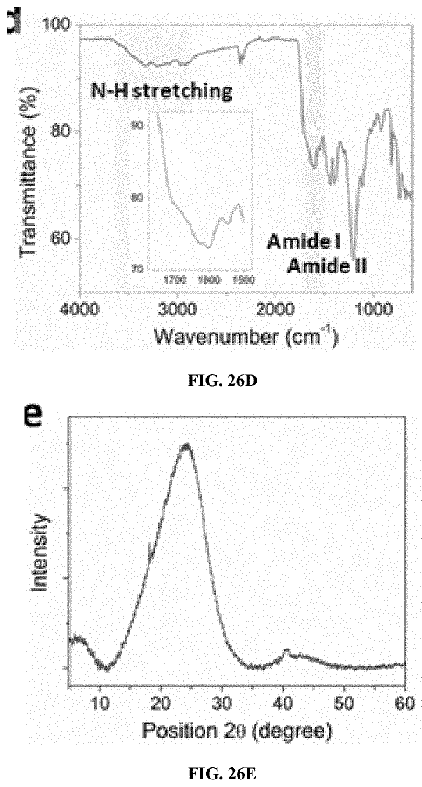

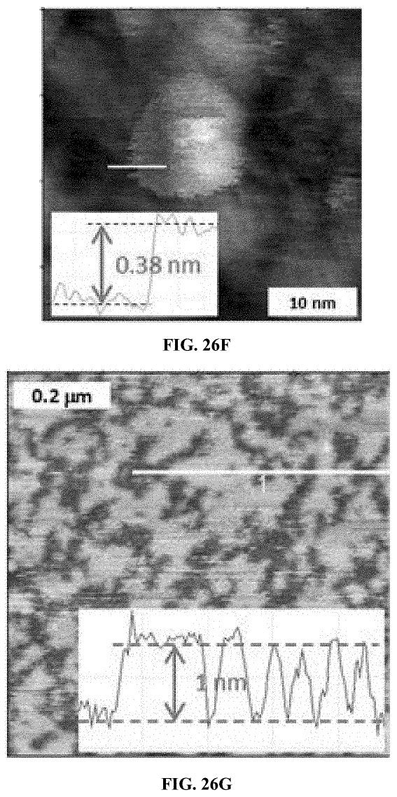

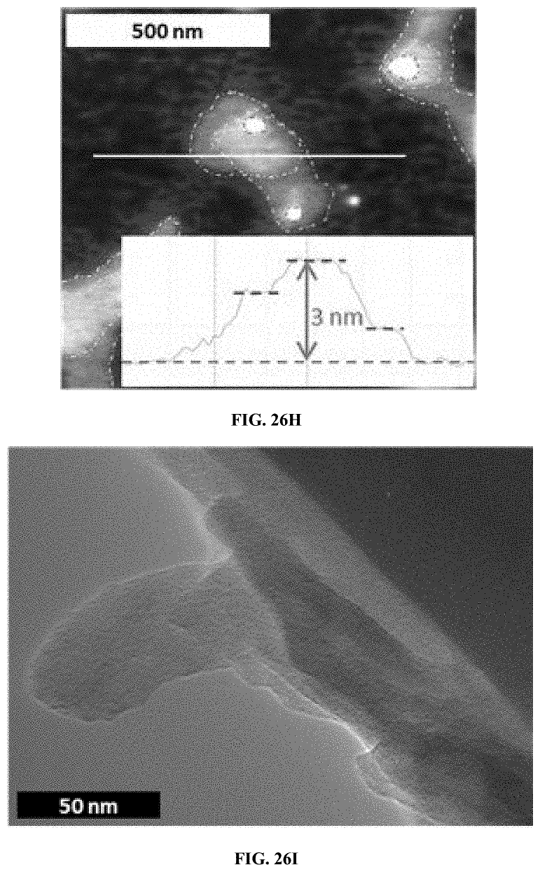

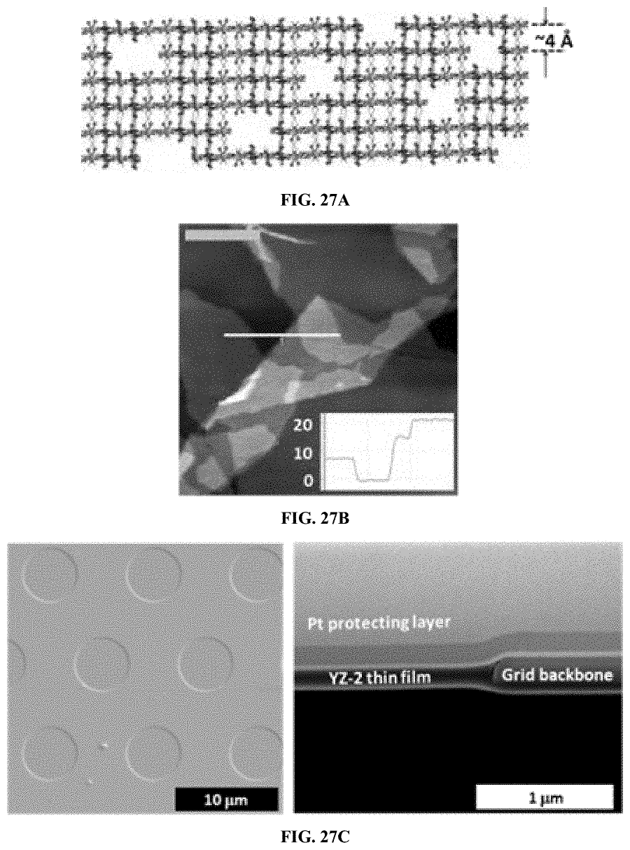

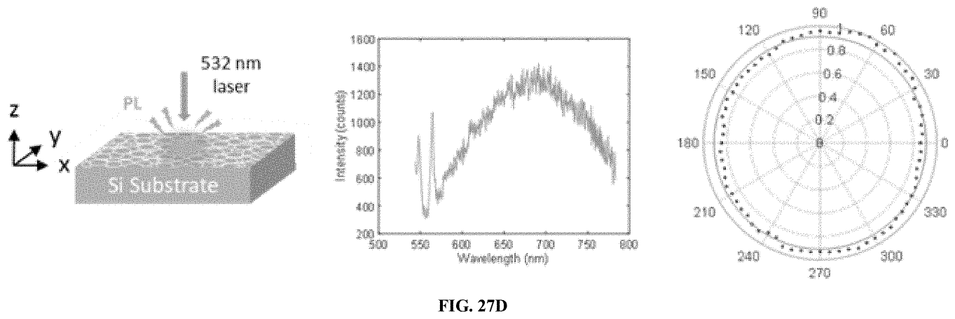

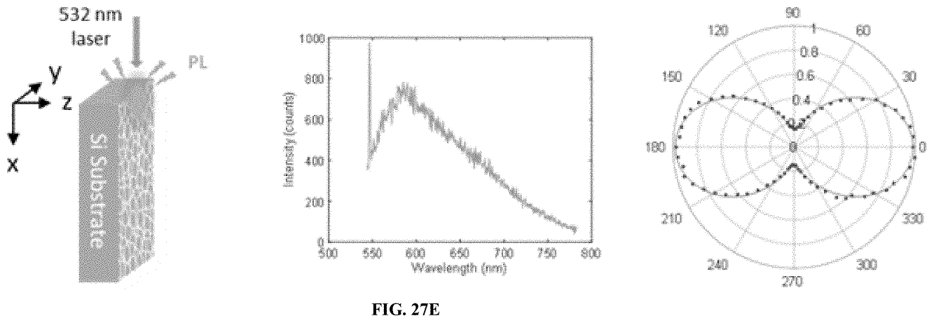

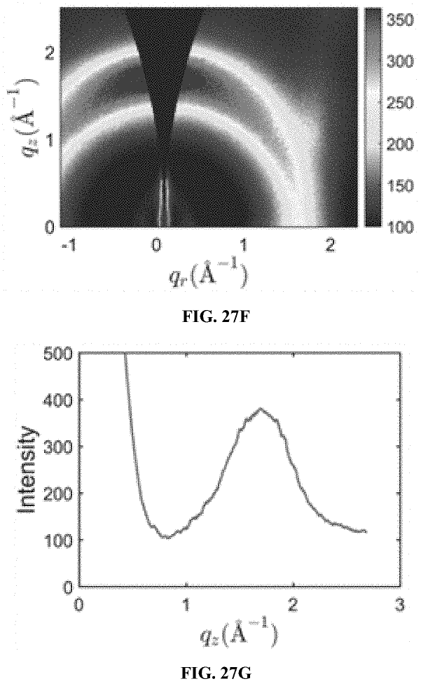

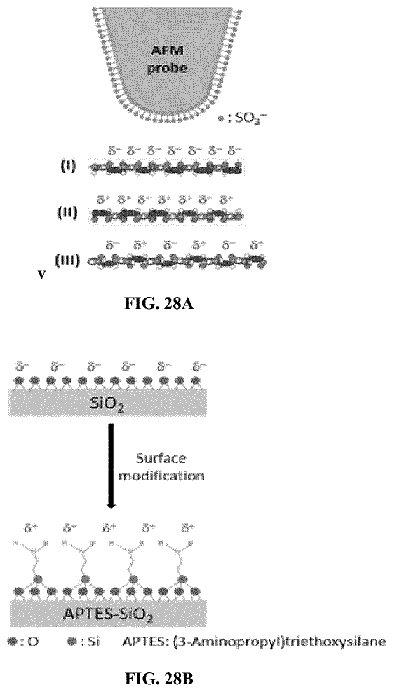

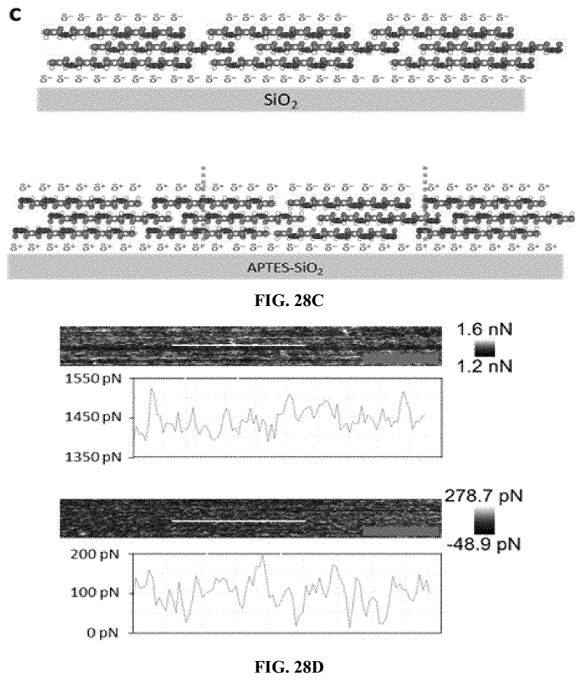

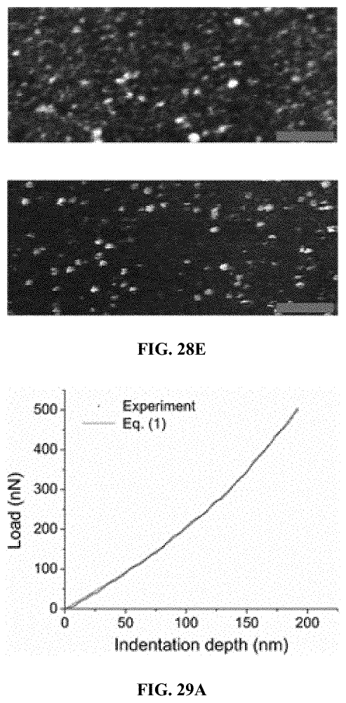

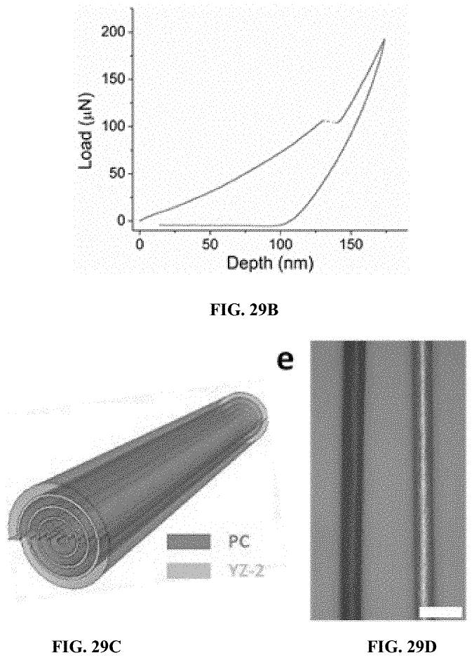

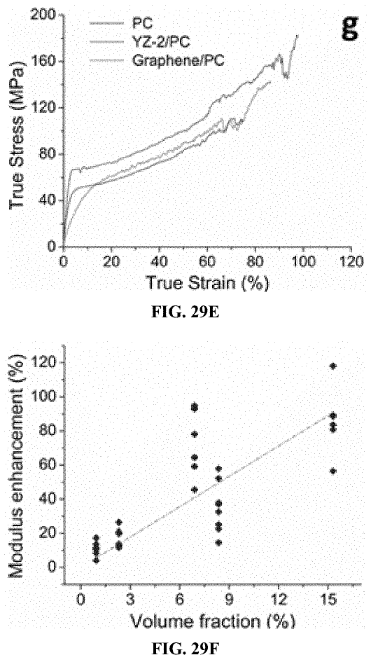

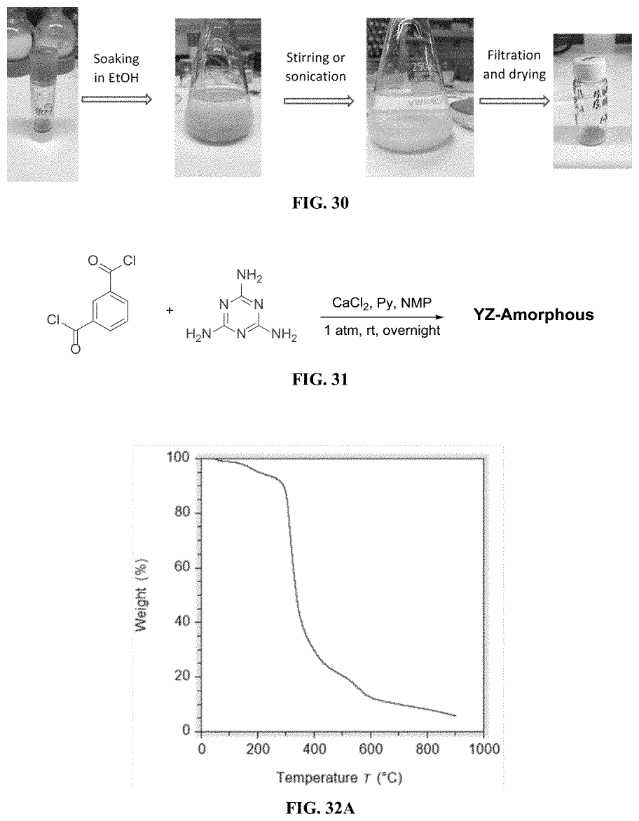

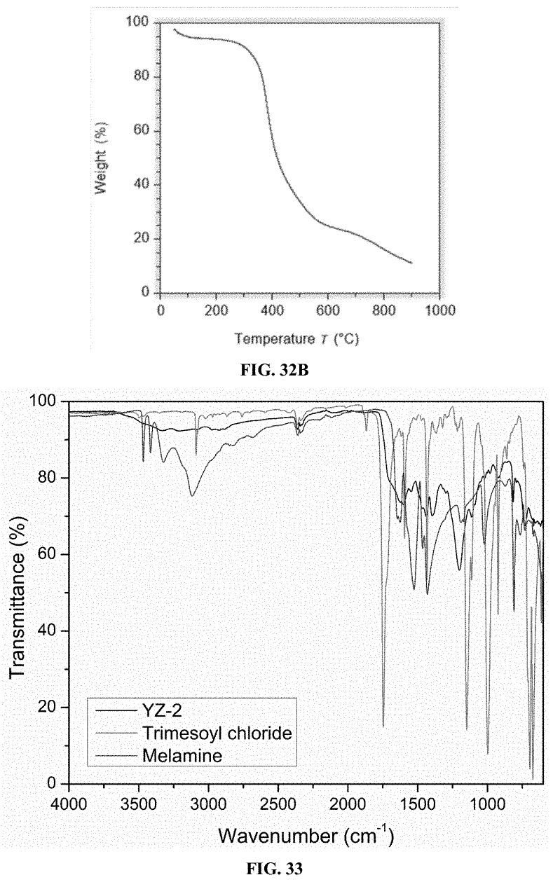

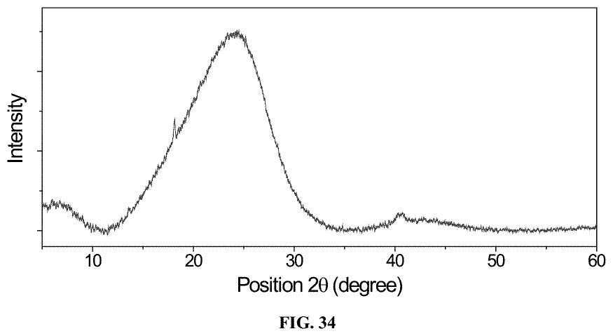

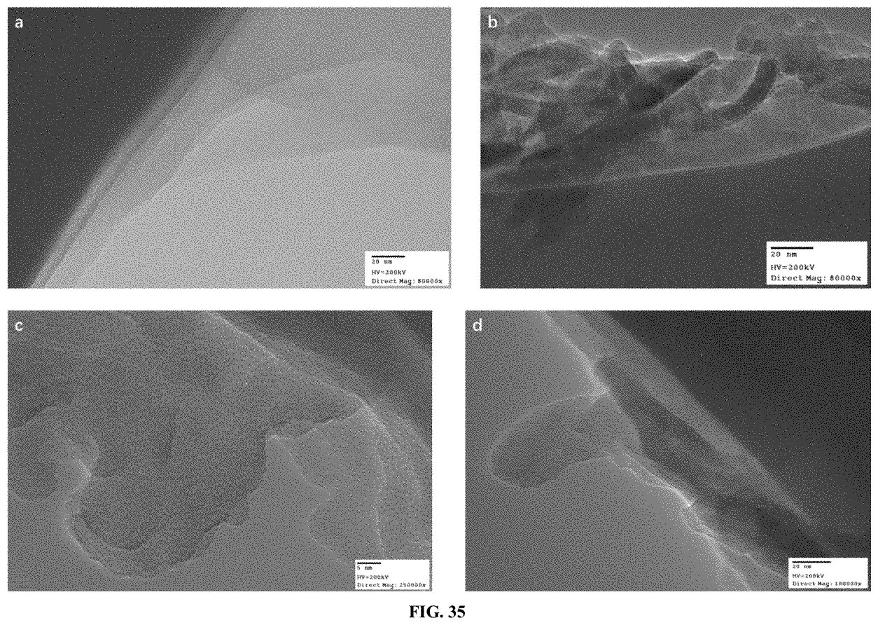

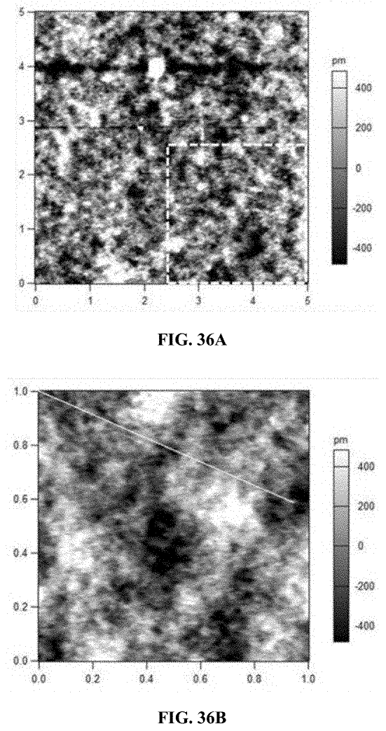

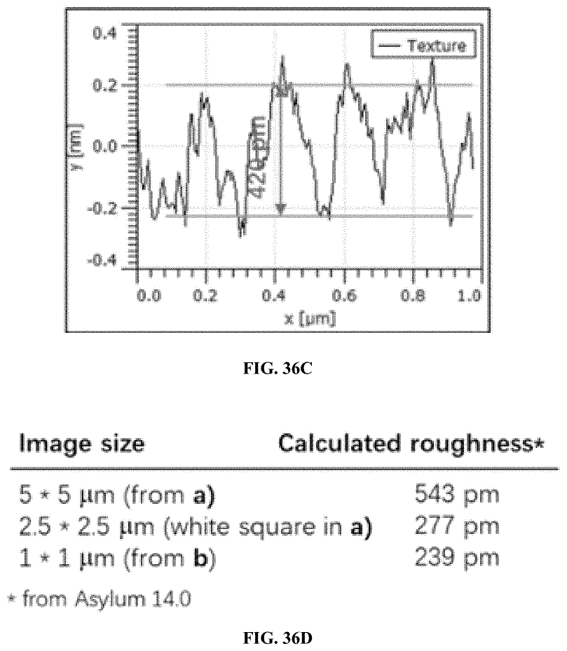

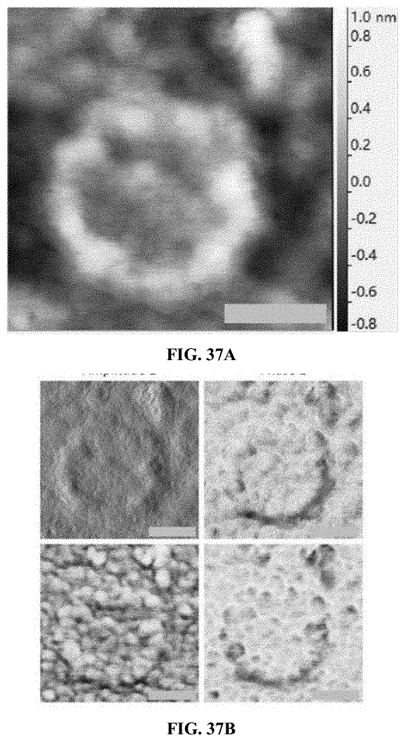

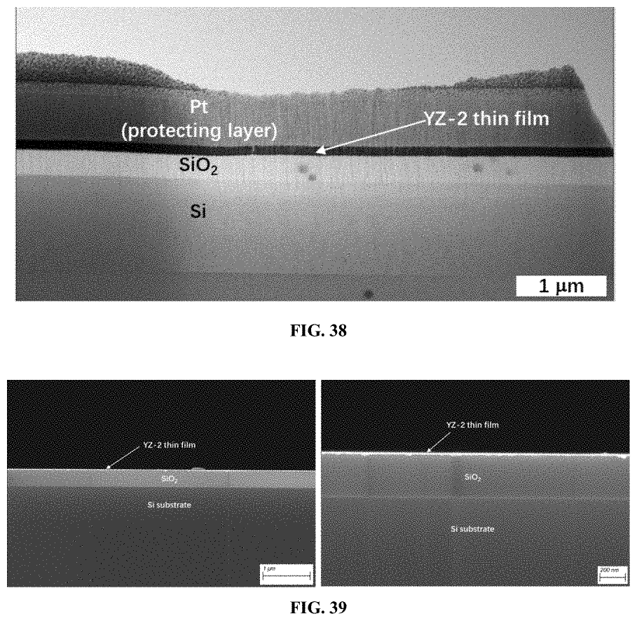

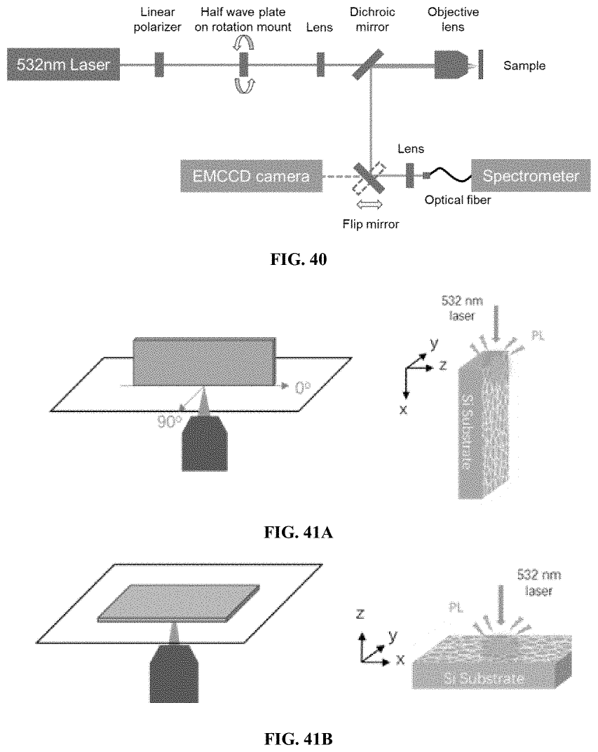

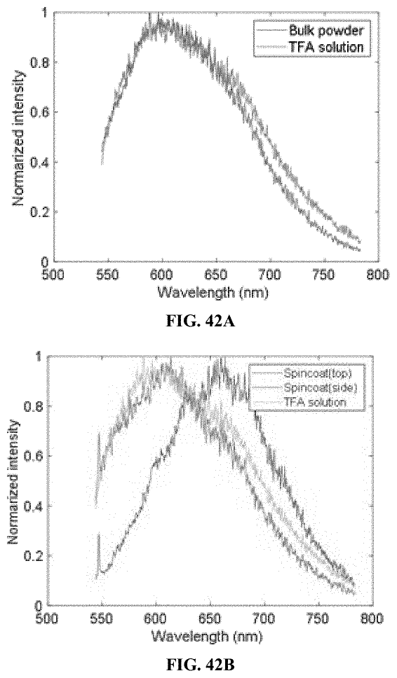

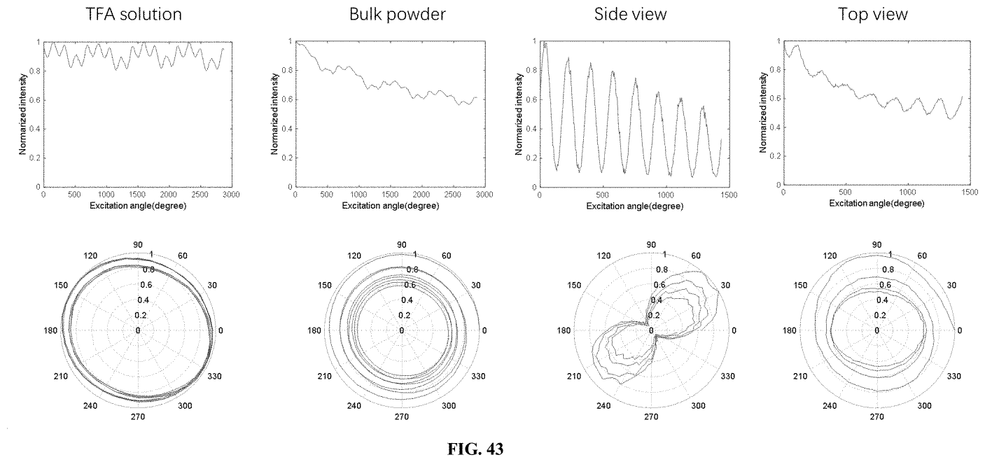

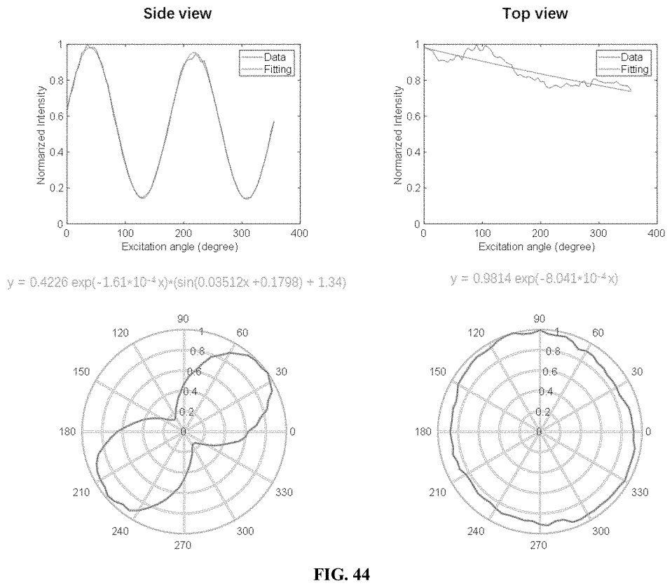

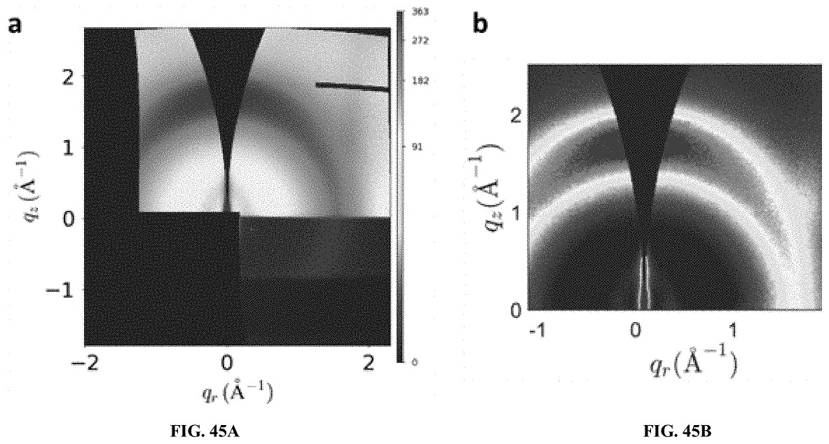

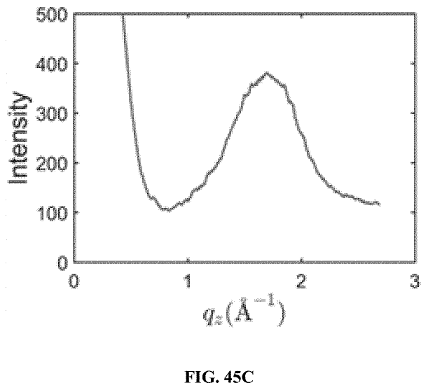

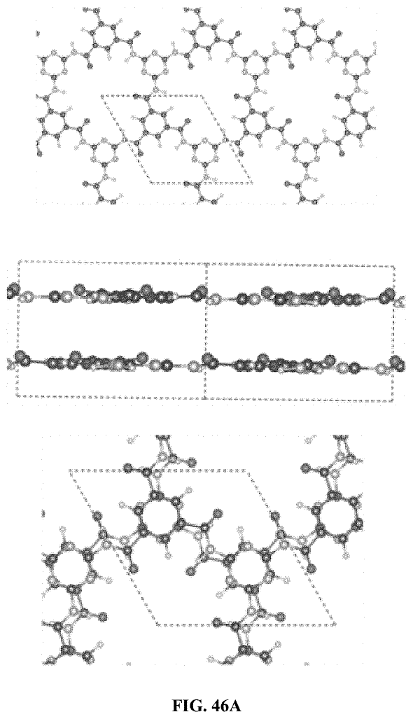

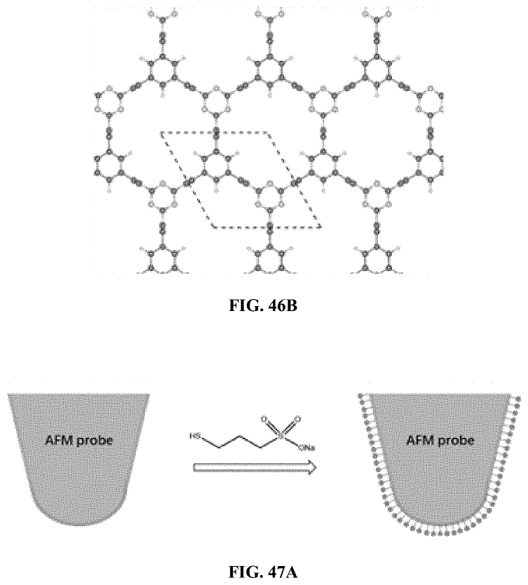

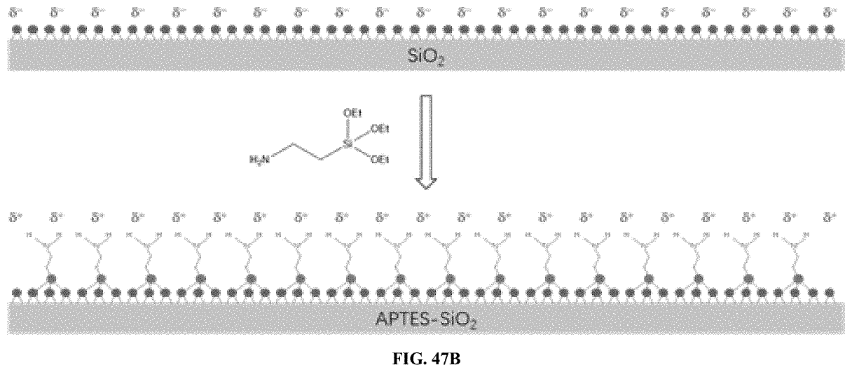

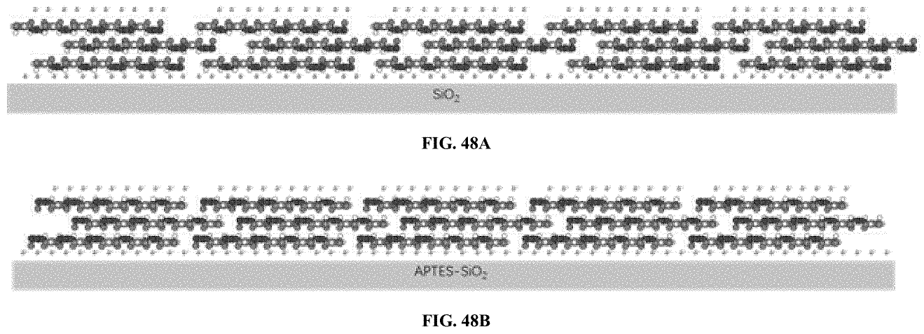

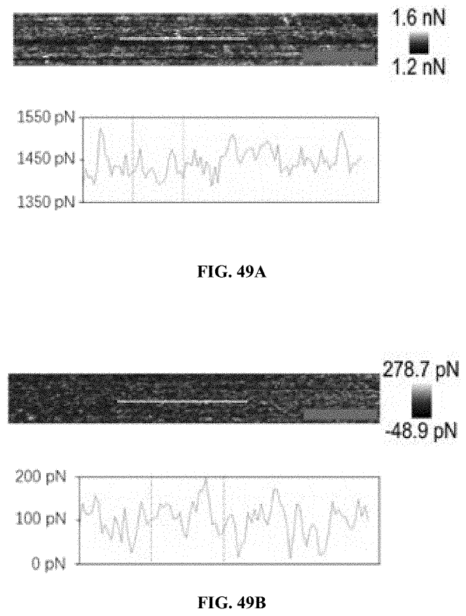

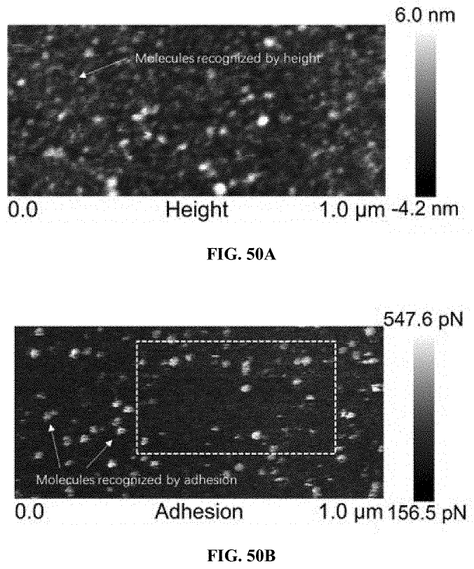

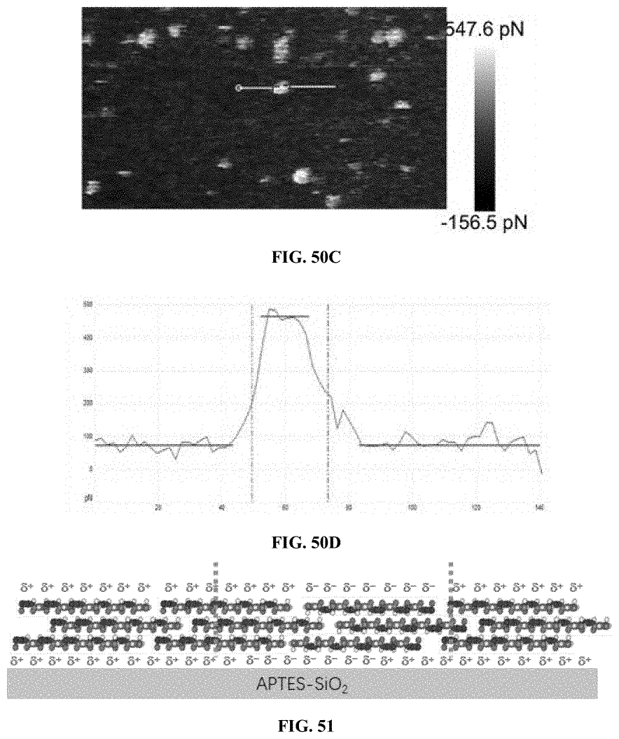

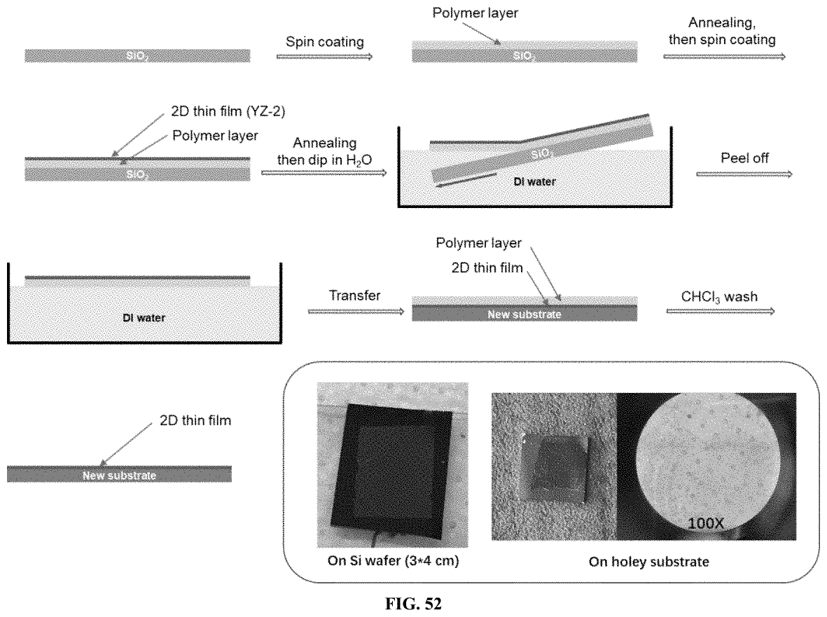

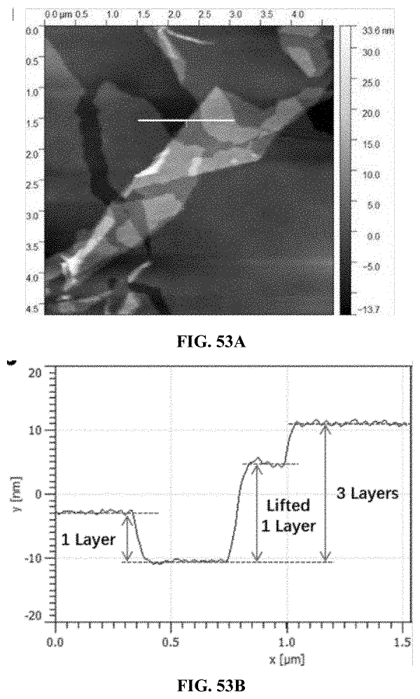

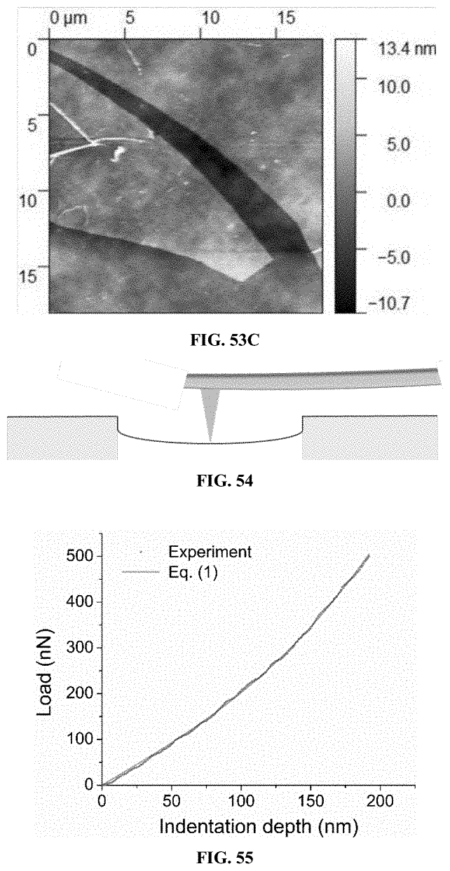

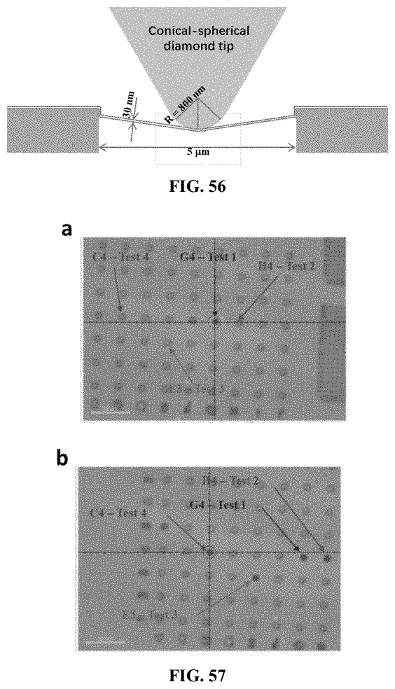

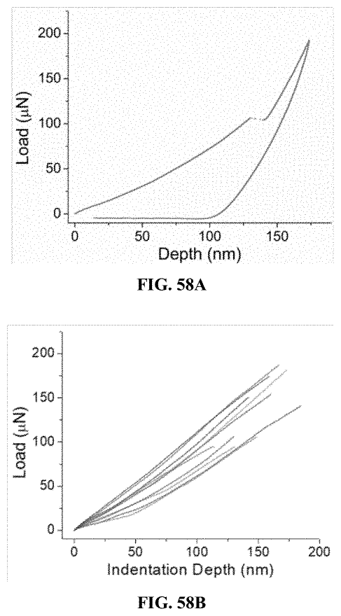

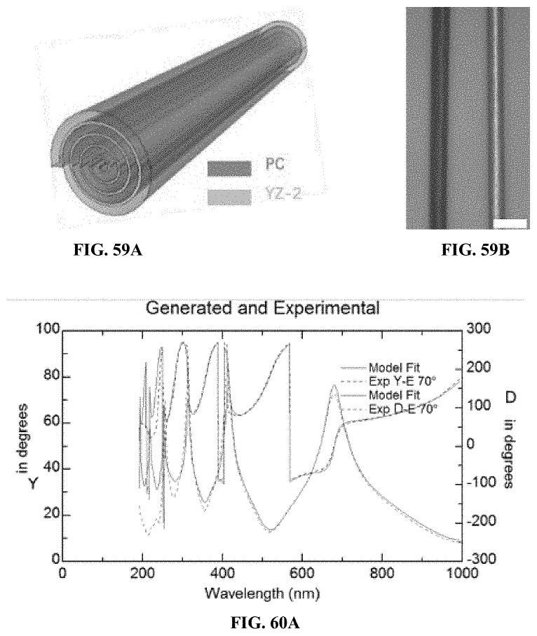

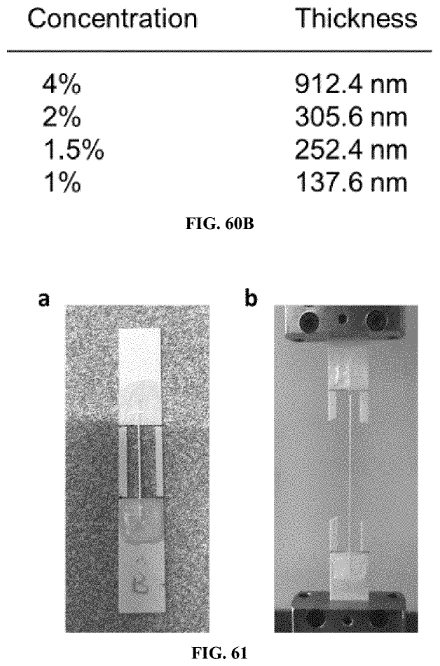

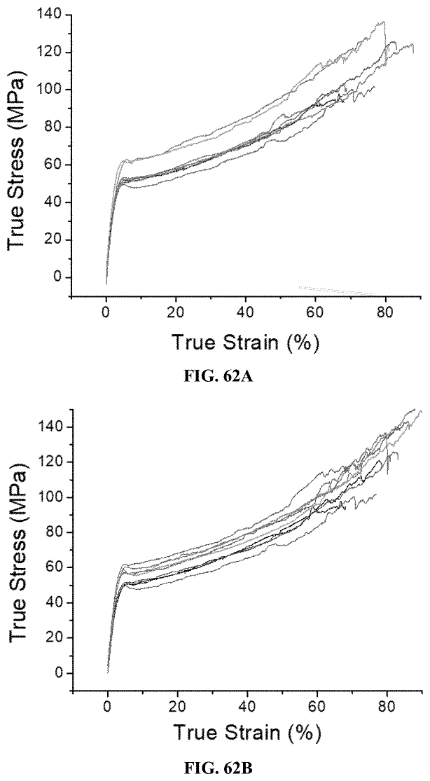

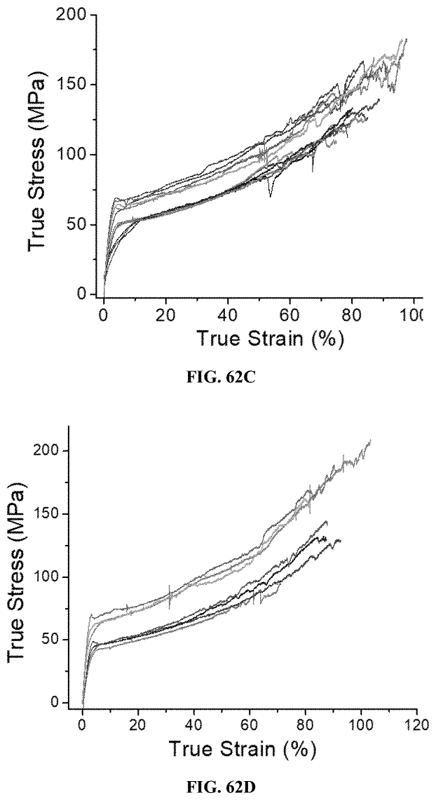

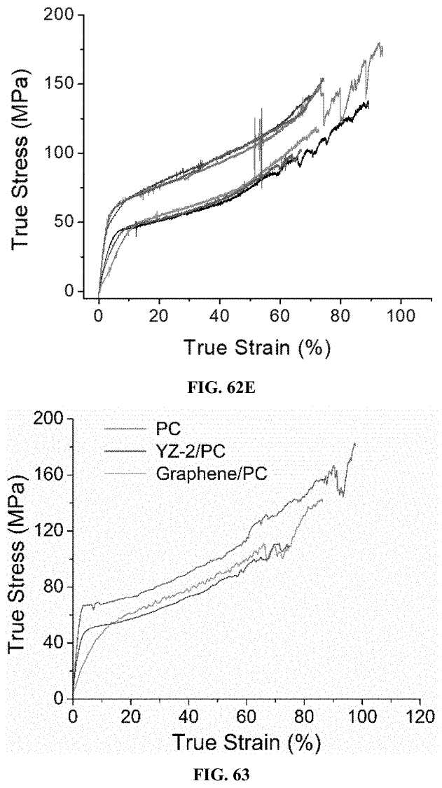

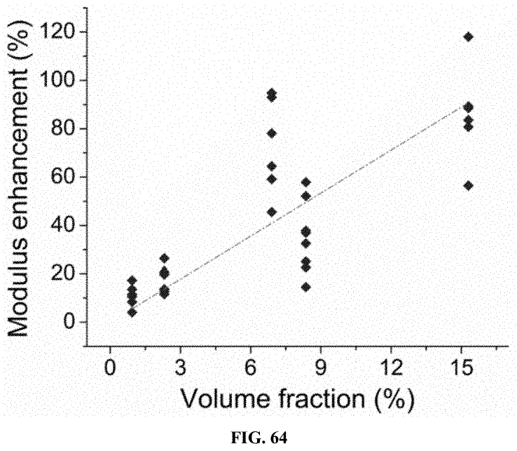

FIG. 7 shows thermal gravimetric analysis of the reaction of FIG. 6 (the out-of-plane product).

FIGS. 8A-8C shows atomic force microscopy data of the material. The molecule height can be about ˜0.4 nm. A single molecule can be rare and hard to find. The system is dominated by bilayers, indicates a very strong interlayer interaction. The molecule in the figure have a rounded shape and a size around 12-15 nm. If the molecule is 3D or amorphous, the height would be much larger than 0.4 nm. As an example, thickness of graphene is 0.34 nm.

Because single molecules are rare and bilayers are always dominant, this can indicate a strong tendency to form dimer (energetically favored).

FIGS. 9A-9C show that the thickness of bilayer can be around 0.92 nm

FIG. 10 shows the thermo Stability of the in-plane product. There is no significant XRD peak change with heating.

FIGS. 11, 12 and 13A-13B show atomic force microscopy data for the material.

FIG. 14 shows scrolled fibers are made from thin films, due to the small volume ratio, the ultimate strength is similar but the toughness (the energy absorbed by the material before its breakage, equals to the area under the curve) is greatly enhanced. Nanoindentation gives us 2D Young's modulus, which doesn't exist in 1D strength materials such as Kevlar, carbon fiber and UHMWPE. The scrolled fiber experiments highlight the potential application in composites. The composite is easy to make and the volume ratio is tunable. With higher volume ratio, larger strength and toughness can be expected.

FIG. 15A shows a stacking dominant structure in which the angles of amide bond are relatively small (amides are nearly in the 2D plane). This can lead to weak interlayer interaction, low density of HB, small interlayer distance (˜0.3 nm in AFM), nice short-range stacking in z axis (showing in XRD and HR-TEM), lack of long-range assembly in xy plane (film size is limited), both monolayer and bilayer were observed in AFM (mostly monolayers); and no surface area (BET <10 m²/g), probably due to AB stacking.

FIG. 15B shows a hydrogen bonding dominant structure. The angles of amide bond are relatively large (amides are out of the 2D plane), strong interlayer interaction, high density of HB (promising as ultra-strong 2D materials), large interlayer distance (˜0.5 nm in AFM), randomly but strongly stacking in z axis (no sharp peaks in XRD), nice long-range assembly in xy plane (can form continuous film), both monolayer and bilayer were observed in AFM (but dominated by bilayers), no surface area (BET <10 m²/g), probably due to random stacking

The orientation of the amide bond is important, it dictates whether interlayer hydrogen bonding (HB) can be formed. According to our study, these amide bonds may have different chemical environments and orientations. That is to say, some amide bonds can form strong HB while some can't, but overall, this material has high density HBs.

Stacking/assembly is based on hydrogen bonding, which is not as order as π-π stacking. So, after random stacking to form 3D structure, this material lose its order in z axis (no peak was observed in powder XRD). This material can have a Janus structure, namely, the two faces of the molecule are not equal. This Janus structure is perfect for stacking, like magnets. For more details, please see chemical AFM study.

FIG. 16 depicts other potential structures of the material. FIGS. 17A and 17B show that two structures, simulation shows that they are energetically similar (˜2 Kcal/nanopore). However, the trans structure can be ruled out by the chemical AFM.

FIGS. 18 and 19 show additional atomic force microscopy data for the material.

FIGS. 20 and 21A-21B show that molecule size distributions of the out-of-plane structure from adhesion (FIG. 21A) and height (FIG. 21B) are similar.

FIG. 22 shows an approach to irreversible Formation of 2D Polymer: Some Design Principles. One can rely on kinetic control, rather than thermodynamic control. Another important design choice is selection of strong and stable linkages offer thermodynamic stability. The irreversible bond formation makes reaction quick and reproducible. Introduction of Lewis basicity sites for protonation, open up solubility in acid conditions, enhancing processing. It is possible to achieve kinetic control to get highly ordered 2D structures, including materials with smaller nanopore size, less flexible linkage and less degree of freedom and reducing the concentration of one monomer to favor the intramolecular annulation over intermolecular reactions.

Differences in the materials described here using graphamid and COFs as starting points, or leading structures is shown in FIG. 23. An important consideration is choosing the right linkages and nodes. The linkages can be amide, urea, or carbamate linkages. As shown in FIG. 24, the approach can focus on tri-functionalized aromatic cores.

FIG. 25 show that the in-plane structure reaction runs faster when 0.5% of 2D polymer was added at the first beginning (13 min and 18.5 min respectively when the concentration of triacid chloride reach to 2%). The reaction is pseudo first order.

Herein, an irreversible 2D polyaramid system is developed that enables monomers condensing in solution under ambient conditions. This system consists of two small and rigid aromatic cores and planar amide linkages, leading to a 2D network with small-sized nanopores (FIG. 26B). The degrees of freedom in each nanopore is restricted to 6, significantly smaller than most 2D frameworks. Meanwhile, the strong hyperconjugation between amides and their adjacent aromatic rings offers substantial stabilization energy to lock the in-plane conformation in place. One additional advantage of amide is its superb chemical stability. It is well known that 1D polyamides can be dissolved in pure sulfonic acid and spun into fibers. See, for example, Picken, S. J., Vanderzwaag, S. & Northolt, M. G. Molecular and Macroscopic Orientational Order in Aramid Solutions—a Model to Explain the Influence of Some Spinning Parameters on the Modulus of Aramid Yarns. Polymer 33, 2998-3006, doi:10.1016/0032-3861(92)90087-D (1992), which is incorporated by reference in its entirety. To further improve the polymer solubility in milder acids and achieve better processability, triazine cores can be introduced into the structure because its nitrogen atoms can serve as Lewis bases and thus be protonated in acidic mediums. The different electronic nature of triazine and benzene rings can lead to a strong interlayer π-π stacking, which is the basis of self-templating and autocatalysis.

FIGS. 26A-26I show a synthesis and characterization of a two-dimensional (2D) polymer. FIG. 26A shows a cross-sectional view of proposed hydrogen-bonded 2D structure. FIG. 26B shows a synthetic route to 2D polyaramid, termed YZ-2. FIG. 26C shows a Thermal gravimetric analysis (TGA) of YZ-2, YZ-Am (amorphous counterpart of YZ-2, obtained when trimesoyl chloride is replaced by isothaloyl chloride under standard conditions), and melamine. FIG. 26D shows a Fourier-transform infrared (FT-IR) spectroscopy of YZ-2. FIG. 26E shows a powder X-ray diffraction (PXRD) of YZ-2. FIG. 26F shows a high-resolution atomic force microscopy (HR-AFM) image of one individual molecule absorbed on mica and its height profile along the white line (inset). FIG. 26G shows an AFM image of bilayer nano clusters and its height profile (inset). FIG. 26H shows an AFM image of stacked nanosheets; inset shows the height profile along the white line. FIG. 26I shows a transmission electron microscopy (TEM) image of layered nanofilms at the edge of a thin-film.

The designed 2D polymerization is carried out under ambient and neutral conditions, ensuring that the whole reaction process is far away from chemical equilibrium (FIG. 26A). The resulting material, termed YZ-2, was received as a pale-yellow powder. The Fourier-transform infrared (FT-IR) confirms the completely consuming of starting materials and the formation of amide bonds in both amide I (1600-1700 cm⁻¹) and amide II (1500-1600 cm⁻¹) regions (FIG. 26B). The broadened peaks in these areas suggest that in the scaffold amides exist in different chemical environments. Interestingly, multiple broad and red shifted peaks showing in the range of 3500-2800 cm⁻¹ could be assigned as highly hydrogen bonded N—H stretching modes of amides. This observation suggests that in the bulk material, amides may not be totally flat but tilt to certain degrees and form interlayer hydrogen bonds.⁹ YZ-2 shows a smooth decomposition curve starting at 312° C. (5% weight lose) in thermal gravimetric analysis (TGA), significantly higher than that of melamine (271° C.) and its amorphous counterpart (233° C.), reflecting an additional thermal stability is gain from the 2D concatenation (FIG. 26C). A subsequent differential thermal analysis (DTG) indicates a very high product purity (>95%). The powder x-ray diffraction (PXRD) of YZ-2 shows an imperfect crystalline structure with a peak centered about 25 degree (FIG. 26E), which agrees with our AFM and GIWAXS observation discussed below. Despite of low crystallinity, the 2D nature of YZ-2 is revealed by high resolution atomic force microscopy (HR-AFM). Generally, such extended frameworks are neither soluble nor fusible, which makes further processing and fabrication entirely impossible. See, for example, Kandambeth, S., Dey, K. & Banerjee, R. Covalent Organic Frameworks: Chemistry beyond the Structure. J Am Chem Soc 141, 1807-1822, doi:10.1021/jacs.8b10334 (2019), which is incorporated by reference in its entirety. However, the high density of Lewis bases embedded in the structure and the superb chemical stability of amide bonds render YZ-2 a highly soluble nature in trifluoroacetic acid (TFA), forming a homogenous solution without any additional stabilizer. Therefore, individual molecules are deposited onto a mica surface via droplet evaporation of a highly dilute solution and measured with AFM, showing a rounded shape with a diameter of roughly 15 nm and an apparent height around 0.38 nm (FIG. 26F). The clear edge and single-monomer-thickness clearly prove its 2D nature, since any growth out of the 2D plane will generate molecules thicker than typical monolayer 2D materials. Further tuning of the deposition conditions reveals more intermediate states. Firstly, continuous bilayer flakes are formed (FIG. 26G) and then start to merge, affording larger bilayer nanosheets (FIG. 26H). Those nanosheets are able to stack on top of each other in a random way and lead to terraces formation (FIG. 26H). The observation that each step is around 1 nm, slightly larger than two times of single layer, could be attributed to the formation of interlayer hydrogen bonds. After that, continuous nanofilms were generated as subunits and densely packed into thicker films, as shown in transmission electron microscopy (TEM) images focusing at the edge of liquid exfoliated powders (FIG. 26I).

FIGS. 27A-27G show characterization of YZ-2 thin-films. FIG. 27A shows a cross-sectional view of proposed hydrogen-bonded 2D films. FIG. 27B shows atomic force microscopy (AFM) image of a transferred YZ-2 nano thin-film at film edges near which cracks, wrinkles, and folds are observed. The inset shows the height profile along the white line. Scale bar: 1 μm. FIG. 27C shows scanning electron microscopy (SEM) images of a suspended YZ-2 film on a Si₃N₄ TEM Grid. Left: top view; right: cross-sectional view. FIG. 27D shows top view photoluminescence (PL) measurement of YZ-2 nano thin-film at 532 nm excitation. Left: schematic illustration; middle: PL spectrum; right: polar plot of top view. Red fitting curve: intensity=0.91. FIG. 27E shows side view photoluminescence (PL) measurement of YZ-2 nano thin-film at 532 nm excitation. Left: schematic illustration; middle: PL spectrum; right: polar plot of side view. Red fitting curve: intensity=0.1452+0.8365*cos2θ. FIG. 27F shows grazing-incidence wide-angle X-ray scattering (GIWAXS) 2D image and its 1D intensity profile (FIG. 27G) near qᵣ=0 A⁻¹ of the YZ-2 film.

For 2D materials, one of the most important applications is fabricating highly oriented homogenous films for structural use or molecular sieving. However, most thin “films” made from 2D materials are actually polycrystals or poorly aligned. See, for example, Varoon, K. et al. Dispersible exfoliated zeolite nanosheets and their application as a selective membrane. Science 334, 72-75, doi:10.1126/science.1208891 (2011); Yeh, T.-M., Wang, Z., Mahajan, D., Hsiao, B. S. & Chu, B. High flux ethanol dehydration using nanofibrous membranes containing graphene oxide barrier layers. J Mater Chem A 1, 12998, doi:10.1039/c3ta12480k (2013); and Medina, D. D. et al. Oriented Thin Films of a Benzodithiophene Covalent Organic Framework. Acs Nano 8, 4042-4052, doi:10.1021/nn5000223 (2014), each of which is incorporated by reference in its entirety. For YZ-2, due to the above revealed strong aggregation tendency, uniform and continuous thin-films are easily generated by spin-coating a TFA solution onto a flat surface. The thickness of those thin-films is well correlated with its solution concentration (FIG. 4C). It is noteworthy that the lower limit of the film thickness is around 2-4 nm, indicating that even a few layers of molecules are enough to form an “infinitely” extended film. Interestingly, all those films are super flat. A negligible surface roughness of 543 pm was observed over a 5*5 μm area (FIGS. 36A-36C), corresponding to a height variation no more than 4 molecular layers. This observation precludes the possibility of polycrystalline film and implies that YZ-2 molecules tend to adapt a flat-on orientation (FIG. 27A). We also developed a film transferring method for rough or even holey substates. As shown in FIG. 52, with the assistance of a polymer layer, a 3*4 cm sized, 7-nm thick YZ-2 nanofilm was transferred intactly to a SiO₂/Si wafer. Again, the transferred film is flat and continuous. Cracks, wrinkles, and folds are observed at the film edges, perfectly illustrate the film thickness and flatness (FIG. 27B and FIGS. 53A-53C). Surprisingly, thin-films can even form across empty holes with a diameter of 5 μm by simple drop-casting, generating suspended films. No polycrystalline feature was observed in both scanning electron microscopy (SEM) top view image (FIG. 27C, left) and cross-sectional view image after focused ion beam (FIB) cutting (FIG. 27C, right).

To further elucidate the film homogeneity and molecular orientation, a polarized photoluminescence (PL) characterization method was developed (FIG. 40). In general, the PL response of YZ-2 is weak and broad, occupying the whole spectrometer along with Si characteristic Raman peaks at 550 and 570 nm. It was found that the PL emission of YZ-2 is affected not only by the incoming laser pathway and also by the linear polarity of laser. Firstly, when the incident laser is perpendicular to the film surface (FIG. 27D, left), a broad PL peak centered at 680 nm was obtained (FIG. 27D, middle). However, if the laser comes from periphery and is parallel to the thin-film (FIG. 27E, left), a distinct PL peak shown at 580 nm (FIG. 27E, middle). This discrepancy in PL emission suggests different excitation modes inside of the film, which is related to the incoming laser pathway. Furthermore, entirely different responses to the linear polarity of laser were observed. For the top-view excitation, when laser polarity rotates in xy plane, the emission shows no angular dependence, revealing that individual molecules are isotropic in that plane (FIG. 27D, right). Whereas in the side-view excitation case, the emission exhibits a nice two-fold symmetry when the laser polarity is rotating in yz plane (FIG. 27E, right), indicating that molecules are well aligned in this plane. All these results suggest a picture that enormous discotic shaped molecules randomly stack on the substrate surface with a flat-on orientation (FIG. 27A), which is highly consistent with our AFM surface topology (FIGS. 37A-37B). This molecular picture is further supported by grazing-incidence wide-angle X-ray scattering (GIWAXS), in which long-range orientation order but no positional order is observed. A diffuse arc in qz axis represents an interlayer spacing in z direction (FIG. 27F), and its peak around 1.8 Å ⁻¹ in the 1D profile (FIG. 27G) corresponds to a spacing of 4 Å, which is close to our AFM observation (FIG. 27F).

FIGS. 28A-28E show chemical force characterization of YZ-2 thin-films. FIG. 28A shows a schematic representation of surface recognition by a sulfonate modified, negative charged AFM probe. In this molecular model, all amides are drawn vertically for better illustration. (I) Janus 2D molecule, negative charged face; (II) Janus 2D molecule, positive charged face; (III) symmetrical 2D molecule surface. FIG. 28B shows chemical modification of SiO₂ substrate flips the surface charge from negative (top) to positive (bottom). APTES: (3-aminopropyl)triethoxysilane. FIG. 28C shows surface recognition can be extended from substrate surface to film surface. Top: YZ-2 film on SiO₂; bottom: YZ-2 film on APTES-SiO₂. However, an imperfection modification could cause a local molecular flipping on the top surface (illustrated between the two pink dashed lines). FIG. 28D shows chemical force mapping of YZ-2 films on SiO₂ (top) and APTES-SiO₂ (bottom) substrates. Adhesion profiles along the white lines are also given under images. Scale bar, 100 nm. FIG. 28E shows correlated height image (top) and adhesion force image (bottom) from YZ-2 film on APTES-SiO₂. Obtained in the same scan under force mapping mode. Scale bar, 200 nm. FIGS. 21A-21B show molecule size distributions from height topology (top) and adhesion force map (bottom). Red curve: Gauss fit of the distribution histogram.

The surface nature of YZ-2 molecules was explored. In principle, YZ-2 could be either symmetric, in which case amides are evenly distributed across the 2D plane and surface charge is balanced on both surfaces (FIG. 28A, III); or asymmetric in which its two surfaces show equal but opposite charges (FIG. 28A, I and II). These two scenarios can be distinguished by chemical force characterization using a SO₃⁻ terminated AFM probe (FIG. 28A and FIGS. 46A-46B and FIGS. 17B-17C). The chemical interaction between the AFM probe and two surfaces of the same molecule, herein presenting as an adhesion force, would be identical in the symmetric case (FIG. 28A, III) but distinct in asymmetric cases (FIG. 28A, I and II). To achieve different surfaces in the asymmetric scenario, we prepared two substrates with different chemical residues (FIG. 28B, top: SiO₂ substrate; bottom: APTES modified SiO₂ substrate) for amide bond (—CONH—) recognition. Once amides are not entirely flat in the 2D plane, the bare SiO₂ substrate tends to absorb molecules on its NH-rich surface and leave the CO-rich surface facing up (FIG. 28C, top), and vice versa for an APTES-SiO₂ substrate (FIG. 28C, bottom). This surface recognition can be further extended, layer by layer, all the way to the top of the film, offering different film surfaces that can be characterized by AFM force mapping (FIG. 28C). Indeed, chemical force microscopy shows two distinct adhesions (1430 pN for YZ-2 film on SiO₂ substrate and 80 pN for that on APTES-SiO₂, FIG. 28D), indicating a highly asymmetric nature of YZ-2 molecules. Interestingly, in the APTES-SiO₂ case, the height image (FIG. 28E, top) and force image (FIG. 28E, bottom) do not overlay with each other, indicating that the changing of adhesion is not caused by height variation. Therefore, we attribute the white dots in the adhesion force image (FIG. 28E, bottom) to a local molecular flipping caused by an imperfection of APTES modification (exemplified between two pink dash lines in FIG. 28C). This hypothesis is confirmed by its size distribution, which agrees with the molecular size distribution from height (FIG. 28F).

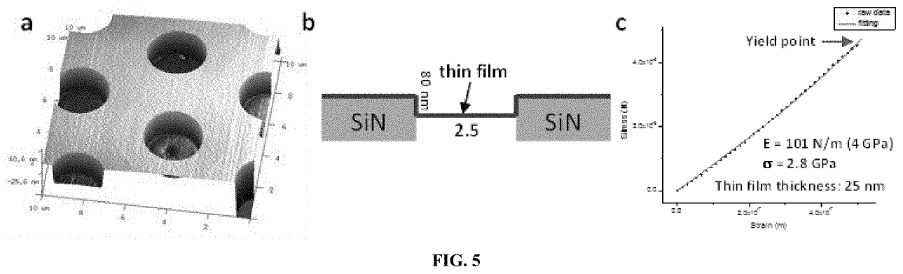

Due to its sturdy interlayer interaction, YZ-2 is expected to be much stronger than conventional 2D vdW materials. In theory, a membrane consisting of well aligned 2D molecules would offer strength isotropically within the plane. Therefore, its specific strength is effectively doubled compared to a weave comprising of 1D fibers. Homogenous and continuous nano thin-films were transferred onto well-defined holey substrates (FIG. 5A and FIGS. 12A-12C) and measured their mechanical properties by nanoindentation (FIG. 29A), a standard mechanical characterization method for 2D membranes. See, for example, Lee, C., Wei, X., Kysar, J. W. & Hone, J. Measurement of the elastic properties and intrinsic strength of monolayer graphene. Science 321, 385-388, doi:10.1126/science.1157996 (2008), which is incorporated by reference in its entirety. For a given elastic, free-standing thin-film, the indenting force (F) can be expressed as

$$F = {σ}_{0}^{2 D} ( π a ) ( \frac{δ}{a} ) + {E}^{2 D} ( {q}^{3} a ) {( \frac{δ}{a} )}^{3}$$

Where σ₀^{2D} is the film pretension, a is the diameter of membrane, δ is the deflection at the center point, E^{2D} is the 2D Young's modulus, and q is a dimensionless constant calculated from Poisson's ratio v. Here both σ^{2D} and E^{2D} are free parameters and can be obtained by fitting the force-displacement data to Eq 1 (FIG. 29A). For a 30 nm-thick, 5 μm sized membrane, elastic modulus was measured by AFM using a 7 nm radius tip. It was found that YZ-2 has a moderate modulus (17.8 GPa), lower than metals but substantial higher than conventional plastics.

The 2D ultimate tensile strength (σ^{2D}) is further determined from (FE^{2D}/4πR)^{1/2}, where R is the tip radius and F is the force at failure. To break this strong thin-film, we switched to a Tribolndenter for higher loads (100-200 μN) (FIG. 29B). Ten different membranes were measured in total and gave tensile strengths ranging from 2-3 GPa. The mean value of σ^{2D} is 2.54 GPa, with a standard deviation of 0.34 GPa. This strength is effectively larger than that of Kevlar (1.8 GPa) after dimension normalization, and almost 5 times stronger than steel, regardless of their huge difference in density.

FIGS. 29A-29F show mechanical properties of YZ-2 thin-films. FIG. 5A shows an AFM 3D reconstruction of a holey substrate covered with suspended YZ-2 thin-films. FIG. 29 A shows a force-displacement curve and its modulus fitting. FIG. 29B shows a film failure under depth control mode. FIG. 29C shows a schematic illustration of an Archimedean scroll fiber. FIG. 29D shows an optical micrograph of a hair (left) and a scrolled fiber (right). Scale bar, 100 μm. FIG. 29E shows representative true stress-strain curves from a 2D composite scrolled fiber, its polycarbonate (PC) control fiber, and a graphene/PC composite fiber (data reproduced from Science 2016, 353, 364). Volume fraction: YZ-2/PC=6.9%, Gr/PC=0.19%. FIG. 29F shows a plot of modulus reinforcement ((E-E_{PC})/E_{PC}) against different volume fractions.

Mechanical response of the composition was further studied using conventional tensile testing methods. Normally those measurements are limited to macroscale and not applicable to nano materials. However, a previously established scroll fiber platform offers an opportunity to convert microscale mechanical properties into macro measurable quantities, and thus study the material behavior in real nanocomposite applications. See, for example, Liu, P. et al. Layered and scrolled nanocomposites with aligned semi-infinite graphene inclusions at the platelet limit. Science 353, 364-367, doi:10.1126/science.aaf4362 (2016); and Kozawa, D. et al. Highly Ordered Two-Dimensional MoS2 Archimedean Scroll Bragg Reflectors as Chromatically Adaptive Fibers. Nano Lett 20, 3067-3078, doi:10.1021/acs.nanolett.9b05004 (2020), each of which is incorporated by reference in its entirety. After layering an additional YZ-2 film onto a polycarbonate (PC) film and scrolling this nanostructure into an Archimedean nanostructured fiber (FIGS. 29C-29D), it was found that the resulting fiber exhibits significant larger elastic modulus and tensile strength than its PC control, even at very low volume fraction (V_{2DP}). For instance, a 6.9% fraction of YZ-2 film enhances the fiber modulus by 72%, while the strength raises from 127 MPa to 170 MPa (FIG. 29E). Importantly, benefiting from high-density of surface polar bonds, YZ-2 film holds the PC matrix together and does not slip with tensile strain. Therefore, the composite fibers show no telescoping effect, a pulling-out phenomenon found between the slippery graphene layer and its polymer matrix and show up as a smooth deformation at low strain (FIG. 29E).

$$E = {E}_{PC} + {V}_{2 DP} {E}_{2 DP}$$

$$\frac{{E}_{2 DP}}{{E}_{PC}} = \frac{( E - {E}_{P C} ) / {E}_{P C}}{{V}_{2 DP}} = {η}_{E}$$

In the absence of telescoping effect, the composite fiber modulus is a linear combination of PC matrix and 2D polymer, written as Eq 2. Thus, the modulus ratio (E_{2DP}/E_{PC}) equals to the reinforcing efficiency (η_{E}) of YZ-2 (Eq 3), which corresponds to the slope of modulus enhancement-volume fraction plot (FIG. 29F). The reinforcing efficiency obtained from our scroll fiber experiments (η_{E}=6.06) is reasonably close to the modulus ratio calculated from our nanoindentation results (E_{YZ-2}/E_{PC}=6.8), further confirms our hypothesis that the “sticky” surface of YZ-2 eliminates slippage at layer interfaces, which provides a basis for further composite development.

A synthetic route to irreversible polymerization in bulk solution that promises mechanically and chemically stable 2D polymers is described, analogous in properties to their 1D organic counterparts. It was found that such polymers have extra-ordinary mechanical properties, exceeding the 1D Kevlar fiber. The 2D polyaramid system we describe also provides new opportunities to 2D polymers with applications to composite materials and molecular sieving membranes.

Methods

Synthesis of YZ-2. A 40 mL vial equipped with a stir bar was added with 126 mg of melamine (1 mmol, 1 equiv.), CaCl₂ (0.5 g), and 265 mg of trimesic acid trichloride (1 mmol, 1 equiv.), followed by 9 mL of N-Methyl-2-pyrrolidone and 1 mL of pyridine. The mixture was stirred at room temperature. After 16 hours, the whole reaction mixture became a gel. This gel was cut into small pieces and then soaked in EtOH (80 mL), followed by 30 min bath sonication (if necessary). The resulting cloudy mixture was further filtrated or centrifuged, followed by deionized H₂O (80 mL) and acetone (80 mL) washing. A pale-yellow solid (232 mg, 82%) was received after house-vacuum drying at 80° C. for 8h.

Preparation of YZ-2 nano thin-film. YZ-2 powder was dissolved in trifluoroacetic acid (TFA), forming a homogenous solution. To a clean SiO₂-covered (300 nm) Si wafer, YZ-2 solution was added on top. Then this wafer was spun at certain rate for 1 min, giving a uniform thin-film. Its thickness can be measured by AFM at scratches made by a fine needle (FIG. 4A).

Atomic force microscopy. AFM imaging was performed on Asylum systems (Cypher S and MFP-3D) and a Bruker Veeco Multimode 8 instrument in AC mode using various probes (Arrow UHF, NPG-10, AC-160, and FASTSCAN-D-SS) for different tasks. Data was processed using the Gwyddion software package and built-in softwares in Asylum and Bruker systems.

Polarized photoluminescence measurement. The whole optical setup is shown in FIG. 40. A continuous-wave 532 nm laser (Edmund, 35-072) was used for excitation. The incident light went through a linear polarizer and a half-wave plate (mounted on a motorized stage), and focused onto the sample using an objective lens (Zeiss, 100×, NA=0.75). Adjust the angle of the half-wave plate to maximize photoluminescence intensity. Then, move the stage a few μm away because YZ-2 has already photobleached to some extend during the focusing and adjustment of the half-wave plate. The signal is collected with a spectrometer (Princeton Instruments, Acton SpectraPro SP-2150 and PyLon). The excitation power for photoluminescence measurements is 500 μW and the exposure time is 10 seconds. For simple PL measurement, spectrometer is used for data collection. However, for polarized PL study, we use an EMCCD camera (Andor, iXon3), which is much more sensitive, to trace a longer time course despite the photobleaching of YZ-2. The polarity of the incident light is controlled by rotating the half-wave plate and the PL signal is collected every 5 degrees with 5 seconds exposure time. The excitation power is 2 μW for excitation polarization. All measurements were conducted at room temperature under air.

Scrolled fiber test. The tensile test was performed on an Instron 8848 Micro Tester. Firstly, the scrolled fiber was glued onto a hollow cardboard using epoxy resin, with a gauge length of 16 mm. Then mount the whole sample onto the micro tester, cut the connecting parts on the cardboard and let the scroll fiber free-stand. The test was carried out at room temperature with a strain rate of 0.05 mm/s using a 10-N load cell. The force-displacement curve is recorded until the fiber breaks off (FIGS. 59A-59B).

Materials

Chemical reagents (melamine, trimesoyl chloride, isothaloyl chloride, CaCl₂, and pyridine) and anhydrous solvents (N-methyl-2-pyrrolidone, acetone, and trifluoroacetic acid) were purchased from Aldrich and used as received. For convenience, syntheses were conducted using standard Schlenk techniques or in an inert atmosphere glovebox unless otherwise stated. However, all starting materials can be also weighted and mixed in ambient atmosphere and then sealed with a cape.

Thermal oxide wafers (SiO₂/Si, oxide thickness: 300 nm) were purchased from Waferpro and diced into certain sizes. TEM grids, highest grade VI Mica discs, ultra-flat Si and SiO₂ substrates were obtained from Ted Pella. AFM probes (Arrow UHF, NPG-10, AC-160, and FASTSCAN-D-SS) were purchased from Oxford instruments, Bruker, Olympus, and NanoWorld.

Polycarbonate (PC) was purchase and had an average molecular weight of 60K.

Analytical techniques

Thermogravimetric analysis (TGA) were operated on a Discovery TGA-1 instrument under N₂ flow. Fourier-transform infrared (FTIR) measurements were performed by using a Bruker ATR-FTIR Spectrometer with a reflection diamond ATR module. Powder X-ray diffraction (PXRD) data was recorded on a PANalytical X′Pert Pro diffractometer using a Cu target (Kal radiation, λ=1.54059 Å). Atomic force microscopy (AFM) images were collected using Asylum MFP-3D, Asylum Cypher S, and Bruker Veeco Multimode 8 instruments and analyzed with Gwyddion or Cypher. Scanning electron microscopy (SEM) images were collected on a Helios 660 from FEI and a Sigma 300 VP from Zeiss. Wide-angle X-ray scattering (WAXS) patterns were acquired on beamline 7.3.3 at the Advanced Light Source (ALS) with a Pilatus 2M detector. N₂ sorption measurements were carried out on a Micromeritics ASAP 2020 System at 77K using a liquid N₂ bath.

Synthesis and Purification of YZ-2

FIG. 6 depicts a synthetic scheme of YZ-2.

To a 40 ml glass vial equipped with a stir bar, trimesoyl chloride (265 mg, 1 mmol, 1 equiv) and melamine (126 mg, 1 mmol, 1 equiv) were added followed by CaCl₂ (500 mg), anhydrous NMP (9 mL), and pyridine (1 mL). The reaction mixture was vigorously stirred overnight at room temperature. During the reaction course, the whole reaction system became a gel. This gel was cut into small pieces, mixed with 80 mL of ethanol, and stirred/sonicated to give a cloudy mixture. The resulting mixture was further filtrated or centrifuged, followed by H₂O (80 mL) and acetone (80 mL) washing. A pale-yellow solid was obtained after house-vacuum drying at 80° C. for 8h.

Note: Although most of the syntheses were operated under N₂ atmosphere in a glovebox, it is just for convenience (most chemicals and anhydrous solvents were stored in glovebox), not mandatory. Starting materials are stable enough to weight in air and the 2D condensation is not sensitive to O₂. No difference was observed when the reaction is carried out in air.

FIG. 30 depicts a reaction work-up and purification of YZ-2.

YZ-Amorphous is also synthesized when trimesoyl chloride (1 equiv) is replaced by isothaloyl chloride (1.5 equiv) under standard conditions and using the same purification method.

FIG. 31 depicts synthesis of YZ-Amorphous.

Thermogravimetric Analysis

Few milligrams of samples were placed in a HT Pt pan and mounted on a Discovery TGA-1 instrument. The measurement was done under N₂ flow with a ramp rate of 5 degree per second.

FIGS. 32A-32B shows thermogravimetric analysis of YZ-Amorphous (FIG. 32A) and YZ-2 (FIG. 32B). YZ-Amorphous is synthesized when trimesoyl chloride is replaced by isothaloyl chloride under standard conditions. Samples were measured under N₂ flow. Ramp rate: 5.00° C. /min to 900.00° C.; isothermal at 50.00° C. for 1 min.

Fourier-Transform Infrared (FT-IR) Spectroscopy

FIG. 33 shows FT-IR spectra of YZ-2 (black), trimesoyl chloride, and melamine.

Powder X-ray Diffraction (PXRD)

Characterization detail: YZ-2 powder was grounded and placed onto a spinning zero-background Si substrate. PXRD measurement was then performed on a PANalytical X′Pert Pro instrument using a Cu target (Kal radiation, λ=1.54059 Å). Sample stage: Open Eularian Cradle (OEC); Temperature: 25° C.; 2 Theta range: 5-60 degree.

FIG. 34 depicts powder X-ray diffraction (PXRD) of YZ-2 powder.

High-Resolution Atomic Force Microscopy (AFM) Characterization

YZ-2 powder was dissolved in TFA (0.1 mg/mL) and dropped on a mica substrate. The sample was then immersed in water several times and scanned with an Asylum Cypher S AFM in AC mode. Ultra-high frequency tips (Arrow UHF) were used under blue drive mode with a small laser. In most cases, due to the strong intermolecular interaction, bilayer clusters were observed. Single molecules are rare and hard to find. By tuning the concentration, discontinuous nano thin films start to show up.

FIGS. 8A-8C show high-resolution atomic force microscopy (HR-AFM) image of one individual molecule absorbed on mica surface (FIG. 8A) and its height profile along the white line (FIG. 8B). FIG. 8C is an image from phase channel gives better contrast than that from height channel.

FIG. 9A shows a high-resolution atomic force microscopy (HR-AFM) images of bilayer nano thin-films on mica surface (panels a and b) and their height profiles along white lines (panels c and d).

FIG. 9B shows high-resolution atomic force microscopy (HR-AFM) image of bilayer clusters on mica surface (panel a) and its height profile along the white line (panel b).

Transmission Electron Microscopy (TEM) Characterization

Preparation of TEM samples: YZ-2 powder was mixed with MeOH and sonicated for 1 min. The dilute mixture was then drop-casted onto a lacey carbon/Cu TEM grid. TEM characterization was conducted after drying.

FIG. 35 shows Transmission Electron Microscopy (TEM) images of layered structures at the edge of liquid exfoliated YZ-2 powder.

Preparation of YZ-2 thin films: YZ-2 powder was allowed to dissolve in different amount of trifluoroacetic acid (TFA), forming clear homogenous solutions. Spin-coating of those solutions onto clean SiO₂/Si wafers offers flat and uniform thin films.

Note: To get uniform thin films on SiO₂/Si wafers, substrates have to be pre-cleaned with acetone and isopropanol using a bath sonicator. Dusts and contaminations will lead to imperfection and discontinuity.

Film thickness measurement: Prepare YZ-2 solutions with different concentrations (0.5, 1, 2, 5, 10, and 15 mg/mL in TFA). Prepare thin films by spin-coating (2000 rpm, 1 min) onto square substrates (length around 1.5 cm). Each concentration was repeated four times. Make scratches with a fine needle and then measure the film thickness using an AFM at scratches (FIG. 4A). Each sample was measured at five different places to get statistics. Alternatively, the film thickness can be also measured by TEM (FIG. 37A-37B) and SEM (FIG. 38). In most cases, AFM is used because it is more facile.

FIG. 4A shows an optical micrograph of thickness measurement. Black dots are dirt on the optical lens.

FIG. 4B shows thicknesses of samples with different spin-coating concentrations.

FIG. 4C shows thickness-concentration dependence of spin-coated films on SiO₂-covered (300 nm) silicon wafers. Standard deviations of the thickness are shown as error bars.

Top view of thin films and surface roughness measurement: The surface topology and roughness of spin-coated thin films were measured by a Cypher S AFM from Oxford instruments and analyzed with Gwyddion or Cypher.

FIGS. 36A-36D show AFM images of spin-coated YZ-2 film surfaces (FIG. 36A and FIG. 36B). FIG. 36C shows texture (height) information along the white line in FIG. 36B. FIG. 36D show calculated roughness from selected areas.

All those spin-coated films have super-flat surfaces. Their roughness usually ranges from 300-400 pm over a 5*5 μm area, similar to a commercial ultra-flat silica wafer. In FIG. 36A, there is a white dot in the upper middle substantially contributing to the surface roughness (543 pm). We attribute it as multiple layer laminates or a 3D amorphous molecule. In a zoomed area (FIG. 36B), one can easily figure out four layers of molecules from their grayscale and the height profile in FIG. 36C shows a step of ˜420 pm, corresponds to a single-molecular thickness.

FIG. 37A shows original height image of a selected area. Scale bar: 50 nm. FIG. 37B shows amplitude and phase images at the first (up) and second (down) eigenmodes. Scale bar: 50 nm.

The HR-AFM characterization also offers some topologic information. However, unlike measurements on mica substrate, the height image is vague, probably due to the soft nature of 2D molecules and their imperfect stacking (FIG. 37A). Fortunately, it was found that the image contrast can be dramatically enhanced at a higher eigenmode. Therefore, in dual AC mode, the amplitude-channel AFM image at the second eigenmode gives a much higher sensitivity to the height variation, showing clear edges for individual molecules (FIG. 37B). Thus, by just measuring the film surface, we are able to get a top-layer molecular size distribution which should also reflect the real one because during the spin-coating process, there is no preselection involved.

Cross-sectional view of thin films and thickness measurement: The uniformity and thickness of thin films can be also measured by TEM (FIG. 38) and SEM (FIG. 39). FIG. 38 shows a cross-sectional view TEM image of YZ-2 thin film on a SiO₂/Si substrate. Oxide thickness: 300 nm. FIG. 39 shows cross-sectional view SEM images of YZ-2 thin film with different magnifications. Oxide thickness: 300 nm. The TEM sample was prepared by Focused Ion Beam (FIB) cutting of a spin-coated film sample followed by mild argon milling while samples for SEM were directly observed at the fresh-cleaved substrate edge after Au sputtering of a spin-coated film sample. In SEM images, there are some YZ-2 debris sticking to the fractures but wouldn't affect the thickness measurement.

Characterizations of suspended thin films made by drop-casting: Suspended films were formed when dilute YZ-2 solution was drop-casted and dried on a holey TEM grid. The desired films were then characterized by SEM (FIGS. 12A-12C) and AFM (on a different sample, FIGS. 11A-11D). FIGS. 11A-11D show AFM topology (FIG. 11A), height information (FIG. 11B), and 3D reconstruction (FIG. 11C) of suspended thin films. Hole size of the TEM grid: 2.5 μm. FIGS. 12A-12C show top view SEM images of suspended films before (FIG. 12A) and after (FIG. 12B) focused ion beam (FIB) cutting. FIG. 12C shows a cross-sectional view of FIB cut suspended film. Hole size of the TEM grid: 5 μm.

In FIG. 11A, an imperfect thin film (hole #1) was observed, containing a dip in the middle of the membrane (FIG. 11B). There is also an empty hole in the bottom left corner (hole #3). The suspended films first grow along the wall of the grid holes, and then cross it. This observation is similar to that of suspended graphene films and the deep of thin-film implies the strength of substrate-film affinity. See, for example, Bunch, J. S. et al. Impermeable atomic membranes from graphene sheets. Nano Lett 8, 2458-2462, doi:10.1021/n1801457b (2008) and Lee, C., Wei, X., Kysar, J. W. & Hone, J. Measurement of the elastic properties and intrinsic strength of monolayer graphene. Science 321, 385-388, doi:10.1126/science.1157996 (2008), each of which is incorporated by reference in its entirety.

Polarized Photoluminescence (PL) Characterization

Optical setup: The whole optical setup for photoluminescence measurements is shown in FIG. 40. A continuous-wave 532 nm laser (Edmund, 35-072) was used for excitation. The incident light went through a linear polarizer and a half-wave plate (mounted on a motorized stage), and focused onto the sample using an objective lens (Zeiss, 100×, NA=0.75). Adjust the angle of the half-wave plate to maximize photoluminescence intensity. Then, move the stage a few μm away because YZ-2 has already photobleached to some extend during the focusing and adjustment of the half-wave plate. The signal is collected with a spectrometer (Princeton Instruments, Acton SpectraPro SP-2150 and PyLon). The excitation power for photoluminescence measurements is 500 μW and the exposure time is 10 seconds. For simple PL measurement, spectrometer is used for data collection. However, for polarized PL study, we use an EMCCD camera (Andor, iXon3), which is much more sensitive, to trace a longer time course despite the photobleaching of YZ-2. The polarity of the incident light is controlled by rotating the half-wave plate and the PL signal is collected every 5 degrees with 5 seconds exposure time. The excitation power is 2 μW for excitation polarization. All measurements were conducted at room temperature under air.

Sample preparation and mounting: First, spin-coat YZ-2 films onto clean SiO₂/Si substrates. For top view measurement, the sample is fixed onto a glass slide with a flat-on orientation. FIGS. 41A-41B show schematic illustrations of experimental setup. FIG. 41A shows a top view. FIG. 41B shows a side view. To protect the YZ-2 film from scratching and contamination, the film side is facing to the glass slide (FIG. 41A). For side view measurement, the sample is cut into two pieces. The freshly cleaved edge is fixed onto a glass slide with an edge-on orientation. The film is perpendicular to the glass slide (FIG. 41B).

Photoluminescence measurement: Before polarized PL study, PL spectra were measured of YZ-2 in bulk powder, solution phase (10 mg/mL), and different oriented samples (FIGS. 42A-42B). FIG. 42A shows a comparison of Photoluminescence data from bulk powder and TFA solution. FIG. 42B shows Photoluminescence response from top view sample, side view sample, and TFA solution.

The fact that both bulk powder (condensed state) and TFA solution (highly dispersed state) offer same PL response indicates that each individual molecule excites and emits on its own, without any synergy. The difference between top view and side view shows the existence of different excitation modes, which are sensitive to the incoming laser pathway.

Polarized photoluminescence study: Data was collected using an EMCCD detector. Linear polarization is controlled by rotating a half-wave plate. FIG. 43 shows Photoluminescence intensity-excitation angle curves (up) and their corresponding polar plots (bottom).

Only side view sample shows angular dependence, indicating that YZ-2 molecules are anisotropically aligned in yz plane (FIG. 42A). Likewise, the lack of angular dependence implies that YZ-2 molecules are isotropically dispersed in xy plane (FIGS. 42B). The intensity decrease observed in bulk powder, top view, and side view is attributed to photobleaching of YZ-2, probably originate from laser heating. After fitting and normalizing data with an exponential decay (from a first-order kinetics), bleaching corrected data was shown in FIG. 44. FIG. 44 depicts fit of the PL intensity with first-order decay (up). Normalized polar plots (bottom) of side view (left column) and top view (right column).

Grazing-Incidence Wide-Angle X-ray Scattering (GIWAXS) Analysis

The transferred spin-coated nanofilm (size: around 1.5*1.5 cm; substrate: SiO₂/Si) was measured at the beamline 11-BM of National Synchrotron Light Source II (NSLS-II). FIG. 45A depicts grazing-incidence wide-angle X-ray scattering (GIWAXS) 2D raw image of YZ-2 thin film. Obtained from beamline 11-BM of the National Synchrotron Light Source II (NSLS-II). FIG. 45B depicts repaired 2D image after fixing the small detector gap by data interpolating. FIG. 45C shows 1D intensity profile near qᵣ=0 A⁻.

For conventional 2D materials such as graphene and h-BN, all covalent bonds are in the 2D plane and there is no out-of-plane dipole movement. However, in the case of YZ-2, if amides are not totally flat and pointing outside of the surface, one would expect local surface charges and out-of-plane dipoles. This phenomenon has been observed in 1D systems. For instance, in Kevlar, the amide planes and aromatic cores are not within a same plane. See, for example, Northolt, M. & Van Aartsen, J. On the crystal and molecular structure of poly—(p—phenylene terephthalamide). Journal of Polymer Science: Polymer Letters Edition 11, 333-337 (1973) and Northolt, M. G. X-Ray-Diffraction Study of Poly(P-Phenylene Terephthal amide) Fibers. Eur Polym J 10, 799-804, doi :Doi 10.1016/0014-3057(74)90131-1 (1974), each of which is incorporated by reference in its entirety. Instead, all amide bonds tilt to certain degrees, resulting from steric hinderance between amides and ortho substitutions (H) on the benzene rings.

FIGS. 46A-46B and FIGS. 17B-17C depict various possible structures. FIG. 46A shows a schematic illustration of an in-plane structure in which all the dihedral angles of amides are 0°. Left: top view of a single layer; middle: side view of a bilayer; right: top view of a bilayer. In this structure, the net surface charge is zero and there is no out-of-plane dipole exists. FIG. 467B shows a schematic illustration of an out-of-plane structure. The amide orientation is set to 90° for better illustration. FIG. 17B shows a ball-and-stick model of a trans out-of-plane structure, in which all the amide dipoles are canceled out. FIG. 17C shows ball-and-stick model of a cis out-of-plane structure, in which all the amides are pointing to a direction.

It is envisioned that a same steric effect may also exist in the 2D polyaramid system, despite of the strong hyperconjugation interactions (FIG. 46B). In this scenario, depending on the molecular symmetry, individual charges and dipoles may or may not cancel out. In the former case, the molecule has a symmetric nature and identical surfaces (FIG. 17B) while in the latter one, the molecule shows a net dipole across the molecular plane, offering two distinct charged surfaces (FIG. 17C). Although the amide orientations in the real structure is unknown, the dihedral angle of amides and benzene rings were exaggerated to 90 degree for a better illustration.

FIGS. 47A-47B depict a modification of gold-coated AFM probes (FIG. 47A) and a surface coating of SiO₂ substrates (FIG. 47B).

FIGS. 48A-48B show that surface recognition leads to different film surfaces. FIG. 48A shows a YZ-2 film on SiO₂ substrate. FIG. 48B shows YZ-2 film on APTES-SiO₂ substrate.

To distinguish all above possibilities, we designed a chemical force spectroscopy measurement in which both the sensor (AFM tip) and substrates are chemically modified to selectively bond with different molecular surfaces. Firstly, the SiO₂ substrate is known to have an oxygen-rich surface and can hydrogen bond with the NH terminal of the amides (—CO—NH—), leaving the CO-rich molecular surface facing up (FIG. 48A). By modifying the SiO₂ substrate with (3-aminopropyl)triethoxysilane (APTES), the substrate surface is covered with a layer of NH₂ residues (FIG. 47B), which would selectively hydrogen bond with the CO terminal of amides, leaving the NH-rich molecular surface outside (FIG. 48B). Those molecular recognition can be further extended to the next YZ-2 layer repeatedly, passing from substrate surface to the film surface. Meanwhile, we coated the AFM tip with a layer of negative charged organic molecules which can “feel” the difference of molecular surfaces (FIG. 47A).

General: Chemical force mappings were performed on a Bruker Veeco Multimode 8 instrument. To eliminate the influence of surface water layer and contaminations, all measurements were done under fluid mode using a liquid cell. Deionized water was used as an experimental medium. Moreover, to further minimize the influence of different probes, all data, including substrate controls, were obtained in one measurement without changing probes.

Modification of AFM probes: To a 20 mL vial, sodium 3-mercapto-1-propanesulfonate (20 mg) was dissolved in 5 mL EtOH to offer a dilute solution. Before use, each AFM probe (gold coated, NPG-10 from Bruker AFM Probes) was immersed in this solution for 10 h (FIG. 47A).

Sample Preparation: APTES-SiO₂ substrates were synthesized by immersing clean SiO₂ substrates in a (3-aminopropyl)triethoxysilane (APTES) solution (100 mg in 4 mL EtOH) for 10 h (FIG. 47B). Samples were made by spin-coating (2000 rpm, lmin) YZ-2 solution (2 mg/mL) onto SiO₂ and APTES-SiO₂ substrates (FIGS. 48A-48B).

Surface adhesions of YZ-2 films on both SiO₂ and APTES-SiO₂ substrates were measured and shown in FIGS. 49A-49B. The significant difference in adhesion force clearly indicates YZ-2 molecule has a highly asymmetric nature in which amides are not evenly distributed across the molecular plane.

FIGS. 49A-49B show chemical force mapping of YZ-2 films on SiO₂ (FIG. 49A) and APTES-SiO₂ (FIG. 49B) substrates. Adhesion profiles along the white lines are also given in the bottom. Scale bar, 100 nm.

FIGS. 50A-50D depict correlated images from height channel (FIG. 50A) and adhesion channel (FIG. 50B). FIG. 50C shows magnified adhesion image from the white rectangle in FIG. 50B. FIG. 50D shows an adhesion profile along the white line in FIG. 50C.

Height image and adhesion image in FIGS. 50A-50B cannot overlay with each other, implies that the changing of adhesion is not caused by height variation. This can be attributed the circular dots in adhesion image to flipped molecules. This flipping may originate from imperfect APTES coating (FIG. 51). For example, FIG. 51 shows that imperfect coating may lead to local molecular flipping.

Another evidence for local molecular flipping is the similar size distributions from both height channel and adhesion channel (FIGS. 21A-21B). FIGS. 21A-21B show lateral size distributions from height image (FIG. 21B) and adhesion force map (FIG. 21A).

Nanoindentation

The nanoindentation is performed on suspended films sitting on holey substrates. The films can be either formed in situ or transferred onto the substrates. The substrates can be Si₃N₄ TEM grids, or Si wafers containing well structures, created by photolithograph. The film thickness is measured by AFM at cracks or edges.

The 2D Young's modulus (E^{2D}) and ultimate tensile strength (σ^{2D}) were measured.

Transferring YZ-2 thin films: Due to the strong interaction between the polar YZ-2 molecules and SiO₂ surface, one may not peel the YZ-2 thin film off a SiO₂ substrate without destroying it. However, we can pre-lay a polymer layer beneath the YZ-2 thin film and peel the whole composite off the substrate. After flipping, this composite can be transferred onto whatever substrates (different materials, different shapes) with the polymer layer facing outside. Subsequent acetone washing can remove the polymer, leaving the YZ-2 film alone on the new substrate. The method can easily handle films with several centimeter size (FIG. 52). For example, FIG. 52 shows transformation of spin-coated YZ-2 films to new substrates. Photos and one micrograph (100×) are included in the inset.

FIGS. 53A-53C AFM images of transferred YZ-2 films on SiO₂ substrates (FIG. 53A and 53C) and its height profile along the white line in FIG. 53A. Membrane thickness was measured at the film edges. The homogeneity of transferred films was demonstrated by AFM, measured at the film edges, near which cracks, wrinkles, and folds were observed (FIGS. 53A and 53C). Again, the film shows a very smooth surface and a steady thickness of 7 nm (FIG. 53B). Suspended films have been previously shown in FIGS. 11A-12C.

Nanoindentation by an AFM: For a 30-nm thick suspended YZ-2 film with a diameter of 5 μm, 2D Young's modulus (E^{2D}) was measured by a Cypher AFM using a 7-nm radius tip (FIG. 54). See, Lee, C., Wei, X., Kysar, J. W. & Hone, J. Measurement of the elastic properties and intrinsic strength of monolayer graphene. Science 321, 385-388, doi:10.1126/science.1157996 (2008), which is incorporated by reference in its entirety. The indenting force (F) can be written as:

$$F = {σ}_{0}^{2 D} ( π a ) ( \frac{δ}{a} ) + {E}^{2 D} ( {q}^{3} a ) {( \frac{δ}{a} )}^{3}$$

Where σ₀^{2D} is the film pretension, δ is the deflection at the center point, α is the membrane diameter, and q is a dimensionless constant calculated from Poisson's ratio v. After curve fitting, one obtained a moderate modulus (17.8 GPa), which is several times higher than typical polymers but lower than metals (FIG. 55).

Nanoindentation by a nanoindenter:The 2D ultimate tensile strength (σ^{2D}) can be further determined from:

σ^{2D}=(FE^{2D}/4πR)^{1/2}

Where F is the force at failure and R is the tip radius. Since tip radius (7 nm) is much smaller than ten times of the film thickness (10*30 nm), at higher force, AFM tip would penetrate rather than break the membrane. Meanwhile, even we replace the sharp tip with a giant tip, the film is still too strong for AFM to break. So, the experiment was switched to a Tribolndenter from Hysitron, which was able to offer strong force (FIGS. 56, 57 and 58A-58B).

FIG. 58A shows a representive force curve from a single measurement. Membrane breaks at 115 μN. FIG. 58B shows a collection of data on multiple membranes. The failures of membranes fall in the range of 100-200 μN, give ultimate tensile strengths ranging from 2-3 GPa. The calculated mean value is 2.54 GPa, with a standard deviation of 0.34 GPa.

Scrolled Fiber Tensile Test

Preparation of composite scrolled fibers: Polycarbonate (PC, Mw: 60K) solutions with different concentrations (1-4% in CHCl₃) were spin-coated onto clean SiO₂/Si wafers. After drying, an additional layer of YZ-2 was introduced by spin-coating and annealing. The resulting composite nanostructures were further scrolled under transverse force to offer desired scrolled fibers (FIGS. 59A-59B). See, for example, Liu, P. et al. Layered and scrolled nanocomposites with aligned semi-infinite graphene inclusions at the platelet limit. Science 353, 364-367, doi:10.1126/science.aaf4362 (2016), which is incorporated by reference in its entirety. All fibers were vacuum dried at 65° C. for 10 h before test.

Note: The wafers that were used herein have a uniform size of 3.5*4.5 cm. After spin-coating of the PC film and the YZ-2 film, the edge of the composite film is trimmed with a razor blade and the film size is controlled to 2.8*3.9 cm. In this study, the scrolling is always along the long axis. So, the length of resulting fiber is around 2.8 cm. FIG. 59A shows a schematic illustration of a composite scroll fiber. FIG. 59B shows a micrograph of a human hair (left) and a scroll fiber (right). Scale bar, 100 μm.

Thickness measurement: The thickness of PC films was determined by an XLS-100 ellipsometer from J. A. Woollam Co. (FIGS. 60A-60B). YZ-2 films were spin-coated on PC films, then transferred and washed with CHCl₃. The thickness of YZ-2 films was then determined by an AFM at scratches in 8 different places. Spin-coating condition I: 2.5 mg/mL, 1500 rpm, 1 min; then 100° C., 1 min. Thickness of YZ-2 film: 8.5±1.37 nm (from 8 different places). Spin-coating condition II: 5.0 mg/mL, 1000 rpm, 1 min; then 100° C., 1 min. Thickness of YZ-2 film: 21.1±1.90 nm (from 8 different places).

FIG. 60A shows experimental data from ellipsometer and its thickness fitting. FIG. 60B shows a thickness of PC films with different PC concentrations. Spin-coating conditions: 4000 rpm, 1 min; then annealed at 100° C. for 4 min.

The volume fraction (V2DP) can be determined as:

$${V}_{2 DP} = \frac{{Thickness}_{2 DP}}{{Thickness}_{PC}}$$

Scroll fiber tensile test: The tensile test was performed on an Instron 8848 Micro Tester. Firstly, the scrolled fiber was glued onto a hollow cardboard using epoxy resin, with a gauge length of 16 mm (FIG. 61, panel a, before tensile test). Then mount the whole sample onto the Instron micro tester, cut the connecting parts on the cardboard and let the scroll fiber free-stand. The test was carried out at room temperature with a strain rate of 0.0005 mm/s using a 10-N load cell. The force-displacement curve is recorded until the fiber breaks off (FIG. 61, panel b, after tensile test).

Data analysis: The engineering strain (ε_{E}) is calculated from the elongation and the original fiber length (16 mm). Meanwhile, the engineering stress (σ_{E}) is obtained by dividing the force by the fiber cross-sectional area, which equals to the thickness of composite film times its length.

The true strain (εₜᵣ) and the true stress (σₜᵣ) can be converted from their engineering strain and stress, using the following equations:

εₜᵣ=1n(1+ε_{E});

σₜᵣ=σ_{E}(1+ε_{E})

The elastic modulus (E) is calculated from the very first part (<3%) of the stress-strain curve, in which the curve is linear. The ultimate tensile strength (σ) is obtained from the failure point.

By combining different PC and YZ-2 spin-coating conditions, we prepared and measured composite fibers with five different volume fractions (0.9%, 2.3%, 6.9%, 7.7%, and 13.3%). The results are shown below, alone with their PC control fibers (FIGS. 62A-62E).

These YZ-2/PC composite scroll fiber results were compared with previous scroll fiber results from graphene/PC composites (FIG. 63). See, for example, Liu, P. et al. Layered and scrolled nanocomposites with aligned semi-infinite graphene inclusions at the platelet limit. Science 353, 364-367, doi:10.1126/science.aaf4362 (2016), which is incorporated by reference in its entirety. The graphene also shows a significant increase on strength even at very low volume fraction (0.2%), indicating a higher enhancement efficiency. However, it decreases the fiber tensile modulus dramatically. This is attributed to telescoping effect, which is common in 2D material/polymer composite scroll fibers. See, for example, Liu, P. et al. Layered and scrolled nanocomposites with aligned semi-infinite graphene inclusions at the platelet limit. Science 353, 364-367, doi:10.1126/science.aaf4362 (2016) and Kozawa, D. et al. Highly Ordered Two-Dimensional MoS2 Archimedean Scroll Bragg Reflectors as Chromatically Adaptive Fibers. Nano Lett 20, 3067-3078, doi:10.1021/acs.nanolett.9b05004 (2020), each of which is incorporated by reference in its entirety. In the YZ-2/PC case, due to the highly polarized surfaces, YZ-2 molecules are not only binding tightly with each other, but also very “sticky” to the PC film surface. This strong intermaterial interaction would be crucial for further composite development.

The Young's modulus (E) was also extracted from force curves and the modulus reinforcement is presented in FIG. 64, showing a linear correlation with the volume fraction. The slope represents the reinforcement efficiency (η_{E}) of YZ-2, equals to:

$$\frac{{E}_{2 DP}}{{E}_{PC}} = \frac{( E - {E}_{PC} ) / {E}_{PC}}{{V}_{2 DP}} = {η}_{E}$$

The η_{E} of YZ-2 is found to be 6.06, reasonably close to modulus ratio obtained from our nanoindentation data (17.8 GPa/2.6 GPa=6.8).

Details of one or more embodiments are set forth in the accompanying drawings and description. Other features, objects, and advantages will be apparent from the description, drawings, and claims. Although a number of embodiments of the invention have been described, it will be understood that various modifications may be made without departing from the spirit and scope of the invention. It should also be understood that the appended drawings are not necessarily to scale, presenting a somewhat simplified representation of various features and basic principles of the invention.

What is claimed is:

1. A method of making a polymer comprising contacting 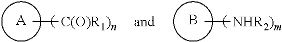
wherein R₁ is a leaving group and R₂ is H or C1-C6 alkyl, n is 2, 3, 4 or 5, m is 3, 4 or 5, and each of the A ring and the B ring is, independently, an aromatic ring,
to form a two dimensional material.

2. The method of claim 1, wherein n cis 3 and m is 3, n is 2 and m is 3, n is 3 and m is 2, n is 4 and m is 2 or n is 2 and m is 4.

3. The method of claim 1, wherein n is 3, m is 3, and the two dimensional polymer includes a structure 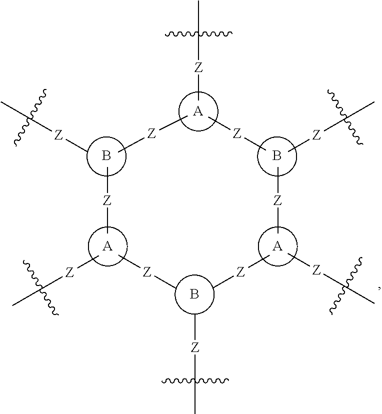
wherein each Z is an amide, urea, or carbamate linkage.

4. The method of claim 1, wherein R₂ is H.

5. The method of claim 1, wherein the A ring is a carbocyclic aromatic.

6. The method of claim 5, wherein the carbocyclic aromatic is phenyl, naphthyl, antrhracenyl, phenanthrenyl, chrysenyl, pyrenyl, corannulenyl, or coronenyl.

7. The method of claim 1, wherein the B ring is a heterocyclic aromatic.

8. The method of claim 7, wherein the heterocyclic aromatic is pyridinyl, pyrimidinyl, triazinyl, pteridinyl, phenyl, naphthyl, antrhracenyl, phenanthrenyl, chrysenyl, pyrenyl, corannulenyl, or coronenyl.

9. The method of claim 1, wherein the A ring is 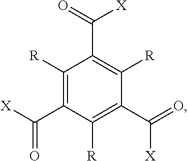
wherein R is H, halo, C1-C6 alkoxy or C1-C6 alkyl and X is a leaving group.

10. The method of claim 1, wherein the B ring is 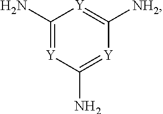
wherein each Y is, independently, N or CR₃, wherein R₃ is H, halo, C1-C6 alkoxy or C1-C6 alkyl.

11. The method of claim 1, wherein X is halo, hydroxyl, methoxy, or acetoxy.

12. The method of claim 1, wherein the two-dimensional material includes a structure

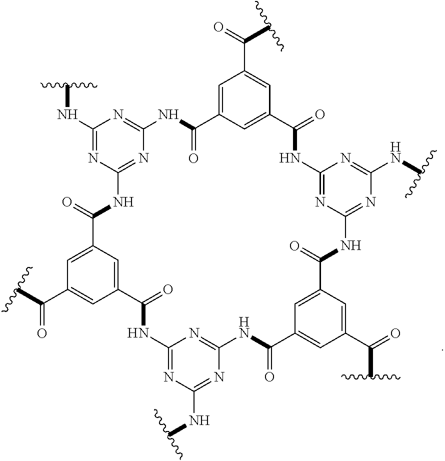

13. The method of claim 1, wherein the polymer includes a plurality of the structure.

14. The method of claim 1, wherein the polymer has an in-plane structure.

15. The method of claim 1, wherein the polymer has an out-of-plane structure.

16. The method of claim 1, wherein the contacting takes place in a solvent selected from trifluoroacetic acid (TFA), trifluoroethanol (TFE), N-methyl-2-pyrrolidone (NMP), 1,3-dimethyl-2-imidazolidinone (DMI), N,N′-dimethylpropyleneurea (DMPU), or hexamethylphosphoramide (HMPA) and salt solutions thereof.

17. A material comprising a two dimensional polymer including a plurality of a first aromatic ring and a plurality of a second aromatic ring, each of the first aromatic ring covalently bonded to at least two of the second aromatic ring by amide bonds.

18. The material of claim 17, wherein the two dimensional material includes a structure 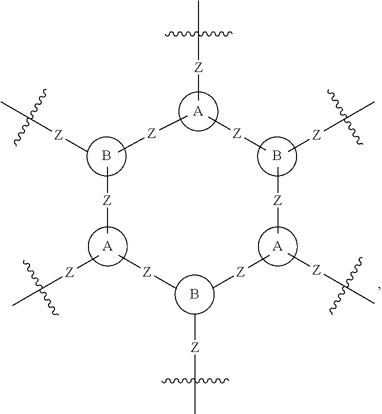
wherein each of the A ring and the B ring is, independently, an aromatic ring and each Z is an amide, urea, or carbamate linkage.

19. The material of claim 18, wherein the A ring is a carbocyclic aromatic.

20. The material of claim 19, wherein the carbocyclic aromatic is phenyl, naphthyl, antrhracenyl, phenanthrenyl, chrysenyl, pyrenyl, corannulenyl, or coronenyl.

21. The material of claim 18, wherein the B ring is a heterocyclic aromatic.

22. The material of claim 21, wherein the heterocyclic aromatic is pyridinyl, pyrimidinyl, triazinyl, pteridinyl, phenyl, naphthyl, antrhracenyl, phenanthrenyl, chrysenyl, pyrenyl, corannulenyl, or coronenyl.

23. The material of claim 18, wherein the A ring is 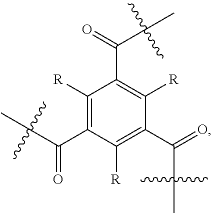
wherein R is H, halo, C1-C6 alkoxy or C1-C6 alkyl.

24. The material of claim 18, wherein the B ring is 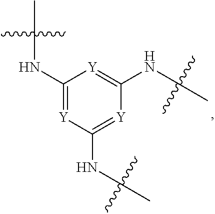
wherein each Y is, independently, N or CR₃, wherein R₃ is H, halo, C1-C6 alkoxy or C1-C6 alkyl.

25. The material of claim 18, wherein the two-dimensional material includes a structure

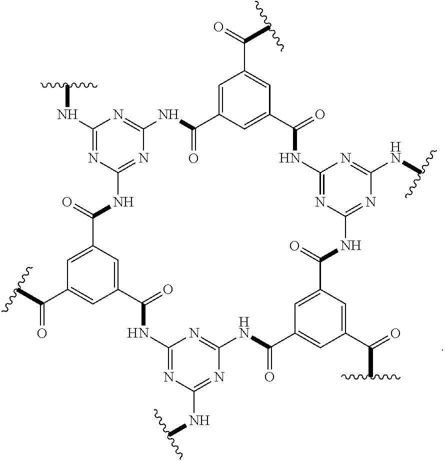

26. The material of claim 17, wherein the material has an in-plane structure.

27. The material of claim 17, wherein the material has an out-of-plane structure.

28. A method of forming a coating of a two-dimensional polymer comprising depositing a material of claim 17 on a surface.
